(19) United States
(12) Patent Application Publication
(10) Pub. No.: US 2025/0105392 A1
(43) Pub. Date: Mar. 27, 2025

(54) BATTERY PACK AND ASSOCIATED THERMAL MANAGEMENT SYSTEM

(71) Applicant: LITENS AUTOMOTIVE PARTNERSHIP, Woodbridge (CA)

(72) Inventors: David NAKHLA, Ancaster (CA); Venkata Prasad ATLURI, Novi, MI (US); Warren WILLIAMS, Oakville (CA); Marc PLANKENBUEHLER, Gelnhausen (DE); Sageevan MAHESWARAN, Bradford (CA)

(21) Appl. No.: 18/893,644

(22) Filed: Sep. 23, 2024

Related U.S. Application Data
(60) Provisional application No. 63/584,859, filed on Sep. 22, 2023.

(51) Int. Cl. H01M 10/635; H01M 10/613; H01M 10/615; H01M 10/625; H01M 10/6556; H01M 10/6563

(52) U.S. Cl. CPC H01M 10/635; H01M 10/613; H01M 10/615; H01M 10/625; H01M 10/6556; H01M 10/6563; H01M 2220/20

(57) ABSTRACT

A power source is provided for integration with a thermal regulation subsystem. The power source includes a battery pack and a heat exchanger that is used to transfer heat between a first heat transfer fluid associated with the thermal regulation subsystem, and a second heat transfer fluid associated with the battery pack. A thermal management unit actuates a second heat transfer fluid valve to control flow of the second heat transfer fluid through flow loops that include and exclude the heat exchanger based on a temperature of the battery pack. The thermal management unit may activate electrically-powered heat transfer elements of the heat exchanger based on the temperature of the battery pack.

### CROSS-REFERENCES TO RELATED APPLICATION

This application claims the benefit of U.S. Provisional Patent Application 63/584,859, filed Sep. 22, 2023, and titled “BATTERY PACK AND ASSOCIATED THERMAL MANAGEMENT SYSTEM”, the contents of which are incorporated herein by reference in their entirety.

### FIELD OF THE DISCLOSURE

This disclosure relates generally to a power system including a battery pack and an associated thermal management subsystem that can be integrated with a thermal regulating subsystem, such as a thermal management subsystem for a traction battery pack of an electric vehicle, or a refrigeration system of a heating ventilation and air conditioning system.

### BACKGROUND

Battery packs should be operated within a prescribed temperature range (e.g., 25° C. to 30° C.) to optimize battery charging and discharge performance and to preserve battery life. Battery packs, however, generate heat in operation and may be exposed to varying ambient temperature conditions. Accordingly, thermal management systems are needed to regulate the temperature of battery packs.

There remains a need in the art for a power system including a battery pack that can be integrated with another thermal regulating subsystem for thermal management of the battery pack. For example, it may be desirable to use a battery pack as a range extender for an electric vehicle that already has an associated thermal management subsystem for a traction battery pack. As another example, it may be desirable to use a battery pack as a power bank for a building or mobile unit having a refrigeration subsystem for heating, ventilation and air conditioning (HVAC) purposes.

### SUMMARY

In an aspect, the disclosure relates to a power system for integration with a thermal regulation subsystem. The thermal regulation subsystem comprises a first heat transfer fluid flow loop for transporting a first heat transfer fluid therethrough. The power system comprises a battery pack, a temperature sensor, a heat exchanger, a second heat transfer fluid flow path, a pump, and at least one second heat transfer fluid valve. The temperature sensor is for monitoring a temperature of the battery pack. The heat exchanger comprises a heat exchanger first flow path and a heat exchanger second flow path. The heat exchanger first flow path extends from an inlet for connection to the first heat transfer fluid flow loop to receive the first heat transfer fluid from the first heat transfer fluid flow loop, to an outlet for connection with the first heat transfer fluid flow loop to discharge the first heat transfer fluid to the first heat transfer fluid flow loop. The heat exchanger second flow path is in thermal communication with the heat exchanger first flow path. The second heat transfer fluid flow path is for transporting a second heat transfer fluid therethrough. The second heat transfer fluid flow path includes a heat exchanger-inclusive flow loop and a heat exchanger-exclusive flow loop. The heat exchanger-inclusive flow loop comprises the battery pack and the heat exchanger second flow path. The heat exchanger-inclusive flow loop comprises the battery pack, but excludes the heat exchanger second flow path. The at least one second heat transfer fluid valve is actuatable to configure the second heat transfer fluid flow path selectively in a heat exchanger-inclusive state and a heat exchanger-exclusive state. The heat exchanger-inclusive state configures the second heat transfer fluid flow path for flow of the second heat transfer fluid through the heat exchanger-inclusive flow loop, but not the heat exchanger-exclusive flow loop. The heat exchanger-exclusive state configures the second heat transfer fluid flow path for flow of the second heat transfer fluid through the heat exchanger-exclusive flow loop, but not the heat exchanger-inclusive flow loop. The thermal management unit comprises a processor operatively connected to the temperature sensor, the at least one second heat transfer fluid valve, and a non-transitory computer-readable medium comprising instructions executable by the processor to actuate the least one second heat transfer fluid valve to configure the second heat transfer flow path in either the heat exchanger-inclusive state or the heat exchanger-exclusive state, based at least on the temperature of the battery pack monitored by the temperature sensor.

In embodiments of the power system, the heat exchanger comprises an electrically-powered heating element in thermal communication with the first flow path and the second flow path. The processor is operatively connected to the electrically-powered heating element. The instructions are executable by the processor to activate the electrically-powered heating element based at least on the temperature of the battery pack detected by the temperature sensor, when the at least one second heat transfer fluid valve configures the second heat transfer fluid flow path in the heat exchanger-inclusive state. In embodiments, the processor may activate the electrically-powered heating element based at least on the temperature of the battery pack monitored by the temperature sensor being less than a predefined heating mode activation temperature. In embodiments, the processor may deactivate the electrically-powered heating element based at least on the temperature of the battery pack monitored by the temperature sensor being greater than a predefined heating mode deactivation predefined temperature that is greater than the predefined heating mode activation temperature.

In embodiments of the power system, the power system further comprises a first heat transfer fluid valve actuatable to selectively allow or prevent flow of the first heat transfer fluid through the heat exchanger first flow path. The processor is operatively connected to the first heat transfer fluid valve. The instructions are executable by the processor to actuate the first heat transfer fluid valve based at least on the temperature of the battery pack monitored by the temperature sensor, when the at least one second heat transfer fluid valve configures the second heat transfer fluid flow path in the heat exchanger-inclusive state. In embodiments, the processor may actuate the first heat transfer fluid valve to allow flow of the first heat transfer fluid through the heat exchanger first flow path based on at least one actuation condition comprising the temperature of the battery pack monitored by the temperature sensor being greater than a predefined active cooling mode activation temperature. In embodiments, the processor may actuate the first heat transfer fluid valve to prevent flow of the first heat transfer fluid through the heat exchanger first flow path based at least on the temperature of the battery pack monitored by the temperature sensor being less than a predefined active cooling mode deactivation temperature that is less than the predefined active cooling mode activation temperature. In embodiments, the power system may further comprise an ambient temperature sensor for monitoring an ambient air temperature. The at least actuation condition may further comprise the ambient air temperature monitored by the ambient temperature sensor being greater than a predefined ambient air temperature.

In embodiments of the power system, the power system further comprises a radiator and a fan. The radiator is disposed in the heat exchanger-exclusive flow loop. The fan is positioned to blow air through the radiator. The processor is operatively connected to the fan. The instructions are executable by the processor to activate the fan based at least on the temperature of the battery pack monitored by the temperature sensor, when the at least one second heat transfer fluid valve configures the second heat transfer fluid flow path in the heat exchanger-exclusive state. In embodiments, the instructions may be executable by the processor to activate the fan based on at least one activation condition comprising the temperature of the battery pack monitored by the temperature sensor being greater than a predefined passive cooling mode activation temperature. In embodiments, the instructions may be executable by the processor to deactivate the fan based at least on the temperature of the battery pack monitored by the temperature sensor being less than a predefined passive cooling mode deactivation temperature that is less than the predefined passive cooling mode activation temperature. In embodiments, the power system may further comprise an ambient temperature sensor for monitoring an ambient air temperature. The at least activation condition may further comprise the ambient air temperature monitored by the ambient temperature sensor being less than a predefined ambient air temperature.

In embodiments of the power system, the power system further comprises a housing, an electrical lead, an inlet connection and an outlet connection. The housing contains the battery pack and the heat exchanger. The electrical lead is conductively connected to the battery pack and extends externally from the housing for connection to an electrical load. The inlet connection extends externally from the housing for establishing fluid communication between the inlet of the heat exchanger first flow path and the first heat transfer fluid flow loop. The outlet connection extends externally from the housing for establishing fluid communication between the outlet of the heat exchanger first flow path and the first heat transfer fluid flow loop.

In embodiments of the power system, the battery pack is an immersion-cooled battery pack, and the second heat transfer fluid comprises a dielectric liquid. In embodiments of the power system, the battery pack is a liquid indirect-cooled battery pack, and the second heat transfer fluid comprises a coolant liquid.

In embodiments of the power system, the inlet of the heat exchanger first flow path is connected to the first heat transfer fluid flow loop, and the outlet of the heat exchanger first flow path is connected to the first heat transfer flow loop.

In embodiments, the thermal regulation subsystem comprises a chiller subsystem and a heater subsystem for regulating a temperature of a second battery that is in thermal communication with the first heat transfer fluid flow loop, and the first heat transfer fluid dissipates heat from the second battery pack. The second battery pack may be a traction battery pack of an electric vehicle.

In embodiments, the thermal regulation subsystem comprises a refrigeration subsystem that comprises, in sequential order, a compressor, a condenser, an expansion valve, and an evaporator, collectively forming the first heat transfer fluid flow loop and the first heat transfer fluid comprises a refrigerant. In embodiments, the inlet of the heat exchanger first flow path is connected to the first heat transfer fluid flow loop downstream of the expansion valve or another expansion valve downstream of the condenser in the first heat transfer fluid flow loop, and the outlet of the heat exchanger first flow path is connected to the first heat transfer fluid flow loop downstream of the evaporator and upstream of the compressor.

In another aspect, the disclosure relates to a method of regulating a temperature of a battery pack. The method comprises: connecting a first flow path of a heat exchanger to a first heat transfer fluid flow loop of a thermal regulation subsystem, wherein the heat exchanger comprises a second flow path in thermal communication with the heat exchanger first flow path; pumping a second heat transfer fluid through a second heat transfer fluid flow path second flow path; using a temperature sensor, monitoring the temperature of the battery pack; and using a processor, and based on the monitored temperature of the battery pack, actuating at least one second heat transfer fluid valve to configure the second heat transfer fluid flow path in either: a heat exchanger-inclusive state wherein the second heat transfer fluid flows through a heat exchanger-inclusive flow loop comprising the battery pack and the heat exchanger second flow path; or a heat exchanger-exclusive state wherein the second heat transfer fluid flows through a heat exchanger-exclusive flow loop comprising the battery pack, but excluding the heat exchanger second flow path.

In embodiments of the method, the heat exchanger comprises an electrically-powered heating element in thermal communication with the first flow path and the second flow path. The method comprises, using the processor, and based at least on the temperature of the battery pack monitored by the temperature sensor, activating the electrically-powered heating element based at least on the temperature of the battery pack monitored by the temperature sensor, when the at least one second heat transfer fluid valve configures the second heat transfer fluid flow path in the heat exchanger-inclusive state.

### BRIEF DESCRIPTION OF THE DRAWINGS

The foregoing and other aspects of the invention will be better appreciated with reference to the attached drawings, as follows:

FIG. 1 is a perspective view of a first embodiment of a power system of the present disclosure, with radiators on the top side of the housing thereof.

FIG. 2 is a perspective view of a second embodiment of a power system of the present invention, with radiators on the side of the housing thereof.

FIG. 3 is a schematic depiction of an embodiment of a power system the present disclosure.

FIG. 4 is schematic depiction of a heat exchanger of the power system of FIG. 3.

FIG. 5 is a schematic depiction of a heat exchanger with electrically-powered heating elements of the power system of FIG. 3.

FIG. 6 is a schematic depiction of an embodiment of a tubular heat exchanger with an electrically-powered heating elements that may be used in the power system of FIG. 3.

FIG. 7 is a schematic depiction of one of the tubes and the vessel of the tubular heat exchanger of FIG. 6.

FIG. 8 is an exploded view of an embodiment of a stacked plate heat exchanger with an electrically-powered heating element that may be used in the power system of FIG. 3.

FIG. 9 is a side elevation, partial cut-away view of the stacked plate heat exchanger of FIG. 8, with the electrically-powered heating element of FIG. 8 mechanically and thermally bonded to the stacked plate heat exchanger.

FIG. 10 is a functional block diagram of an embodiment of a thermal management unit of the power system of FIG. 3, in relation to other components of the power system.

FIG. 11 is an embodiment of a state and mode diagram showing differing operating modes of an embodiment of the power system of FIG. 3, in which the heat exchanger includes an electrically-powered heating element.

FIG. 12 is a schematic depiction of the power system of FIG. 3 in the recirculation mode of FIG. 11.

FIG. 13 is a schematic depiction of the power system of FIG. 3 in the passive cooling mode of FIG. 11.

FIG. 14 is a schematic depiction of the power system of FIG. 3 in the active cooling mode of FIG. 11.

FIG. 15 is a schematic depiction of the power system of FIG. 3 in the heating mode of FIG. 11.

FIG. 16 is a schematic depiction of the power system of FIG. 3 integrated with a thermal management subsystem of an electric vehicle.

FIG. 17 is a schematic depiction of heat transfer in the heat exchanger of the power system integrated with the thermal management subsystem as in FIG. 16, where the heat exchanger of the power system does not include an electrically-powered heating element.

FIG. 18 is a schematic depiction of heat transfer in the heat exchanger of the power system integrated with the thermal management subsystem as in FIG. 16, where the heat exchanger of the power system includes an electrically-powered heating element.

FIG. 19 is a schematic diagram of an embodiment of a control architecture for an embodiment of the power system of FIG. 3 for integration with a thermal management subsystem as in FIG. 16.

FIG. 20 shows the interface between the thermal management unit and sensors of the control architecture of FIG. 19.

FIG. 21 shows the thermal management unit connected to an embodiment of the pump control interface of the control architecture of FIG. 19.

FIG. 22 shows the thermal management unit connected to an embodiment a valve control interfaces of the control architecture of FIG. 19.

FIG. 23 is a table summarizing the state of components of the control architecture of FIG. 19 for different operating modes shown in FIGS. 24 to 27.

FIG. 24 shows the control architecture of FIG. 19 when the power system is in the recirculation mode.

FIG. 25 shows the control architecture of FIG. 19 when the power system is in the passive cooling mode.

FIG. 26 shows control architecture of FIG. 19 when the power system is in the active cooling mode.

FIG. 27 shows the control architecture of FIG. 19 when the power system is in the heating mode.

FIG. 28 is a schematic depiction of the power system of FIG. 3 integrated with a refrigeration subsystem.

FIG. 29 is a schematic depiction of heat transfer in the heat exchanger of the power system integrated with the refrigeration subsystem as in FIG. 28, where the heat exchanger of the power system does not include an electrically-powered heating element.

FIG. 30 is a schematic depiction of heat transfer in the heat exchanger of the power system integrated with the refrigeration subsystem as in FIG. 28, where the power system in which the heat exchanger of the power system includes an electrically-powered heating element.

FIG. 31 is a schematic diagram of an embodiment of a control architecture for an embodiment of the power system of FIG. 3 integrated with a refrigeration subsystem as in FIG. 28.

FIG. 32 is a schematic depiction of another embodiment of a power system of the present disclosure having two battery packs, when integrated with a refrigeration subsystem.

FIG. 33 is a schematic depiction of another embodiment of a power system of the present disclosure having four battery packs, when integrated with a refrigeration subsystem.

### DETAILED DESCRIPTION OF EXAMPLE EMBODIMENTS

### Interpretation

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

The indefinite article “a” is not intended to be limited to mean “one” of an element. It is intended to mean “one or more” of an element, where applicable, (i.e. unless in the context it would be obvious that only one of the element would be suitable).

Any reference to upper, lower, top, bottom or the like are intended to refer to an orientation of a particular element during use of the claimed subject matter and not necessarily to its orientation during shipping or manufacture. The upper surface of an element, for example, can still be considered its upper surface even when the element is lying on its side.

### Terminology

The term “battery pack”, as used herein, refers to an assembly of individual battery cells that are interconnected for electrical conductivity between the battery cells.

The term “immersion-cooled battery pack”, as used herein, refers to a battery pack in which the constituent battery cells are submerged in and in direct contact with a dielectric fluid (e.g., a synthetic dielectric oil) that flows through the battery pack to carry heat away from the battery cells.

The term “liquid indirect-cooled battery pack”, as used herein, refers to a battery pack in which the constituent battery cells are in thermal communication with a channel (e.g., as defined by tubes, plates, or other structure) through which a coolant fluid (e.g., ethylene glycol and/or water) flows to carry heat away from the battery cells without directly contacting the battery cells.

The term “heat transfer fluid”, as used herein, refers to a liquid or gaseous substance or a mixture thereof that is used to carry heat away from a heat source. For example, when the heat source is battery cells in battery pack, the heat transfer fluid may be a dielectric liquid used in an immersion-cooled battery pack or a coolant used in a liquid indirect-cooled battery pack. As another example, when the heat source is ambient heat that is exposed to a refrigeration subsystem, the heat transfer fluid may be a refrigerant (e.g., chlorodifluoromethane known as R22 refrigerant, or a mixture of difluoromethane and pentafluoroethane known as R-410A refrigerant).

The term “processor”, as used herein, refers to one or more electronic hardware devices that is/are capable of reading and executing instructions stored on a memory to perform operations on data, which may be stored on a memory or provided in a data signal. The term “processor” includes a single device or a plurality of physically discrete, operatively connected devices despite use of the term in the singular. The plurality of processors may be arrayed or distributed. Non-limiting examples of processors include integrated circuit semiconductor devices and/or processing circuit devices referred to as computers, servers or terminals having single or multi-processor architectures, microprocessors, microcontrollers, microcontroller units (MCU), central processing units (CPU), field-programmable gate arrays (FPGA), application specific circuits (ASIC), digital signal processors, and combinations of the foregoing.

The term “memory”, as used herein, refers to a non-transitory tangible computer-readable medium for storing information (e.g., data or data structures) in a format readable by a processor, and/or instructions (e.g., computer code or software programs or modules) that are readable and executable by a processor to implement an algorithm. The term “memory” includes a single device or a plurality of physically discrete, operatively connected devices despite use of the term in the singular. Non-limiting types of memory include solid-state semiconductor, optical, magnetic, and magneto-optical computer readable media. Examples of memory technologies include optical discs such as compact discs (CD-ROMs) and digital versatile (or video) discs (DVDs), magnetic media such as floppy disks, magnetic tapes or cassettes, and solid state semiconductor random access memory (RAM) devices, read-only memory (ROM) devices, electrically erasable programmable read-only memory (EEPROM) devices, flash memory devices, memory chips and combinations of the foregoing. Memory may be non-volatile or volatile. Memory may be physically attached to a processor, or remote from a processor. Memory may be removable or non-removable from a system including a processor. Memory may be operatively connected to a processor in such a way as to be accessible by a processor. Instructions stored by a memory may be based on a plurality of programming and/or markup languages known in the art, with non-limiting examples including the C, C++, C#, Python™, MATLAB™, Java™, JavaScript™, Perl™, PHP™, SQL™, Visual Basic™, Hypertext Markup Language (HTML), Extensible Markup Language (XML), and combinations of the foregoing programming languages. Instructions stored by a memory may also be implemented by configuration settings for a fixed-function device, gate array or programmable logic device.

### Power System Overview

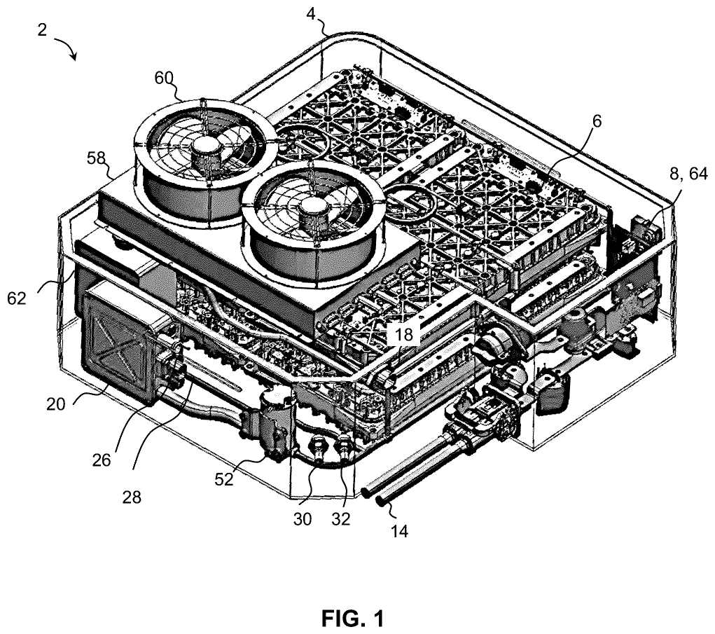

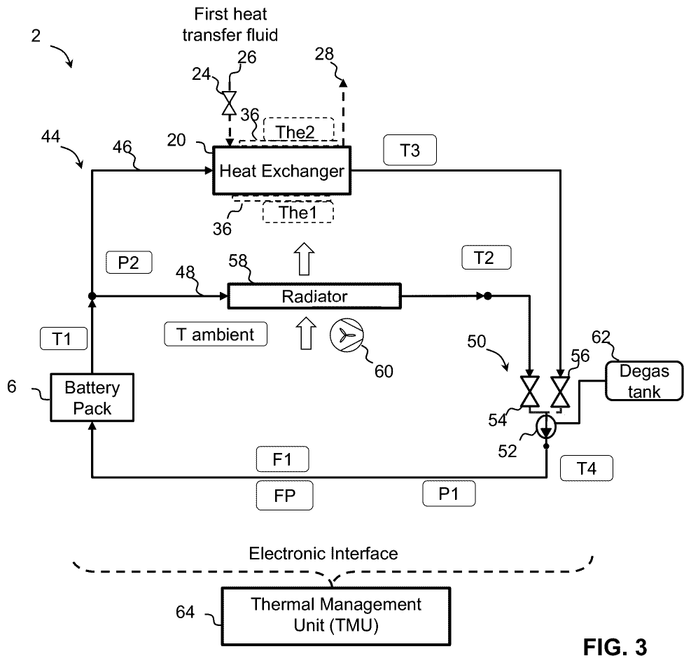

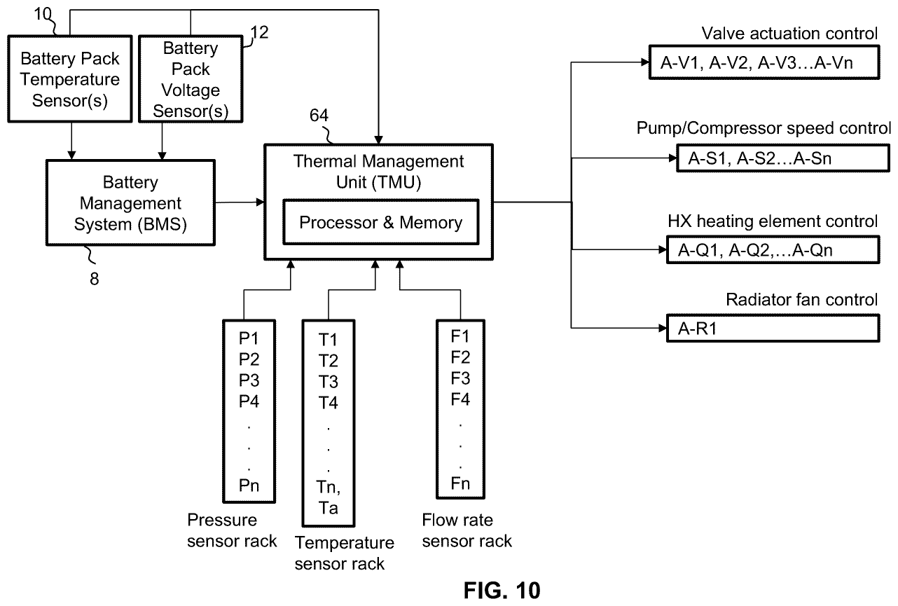

FIG. 1 shows a perspective view of a first embodiment of a power system 2 of the present disclosure. FIG. 3 is a schematic depiction of a power system 2 corresponding to that of FIG. 1. FIG. 10 is a functional block diagram of a thermal management unit 64 of the power system 2 of FIG. 3, in relation to other components thereof.

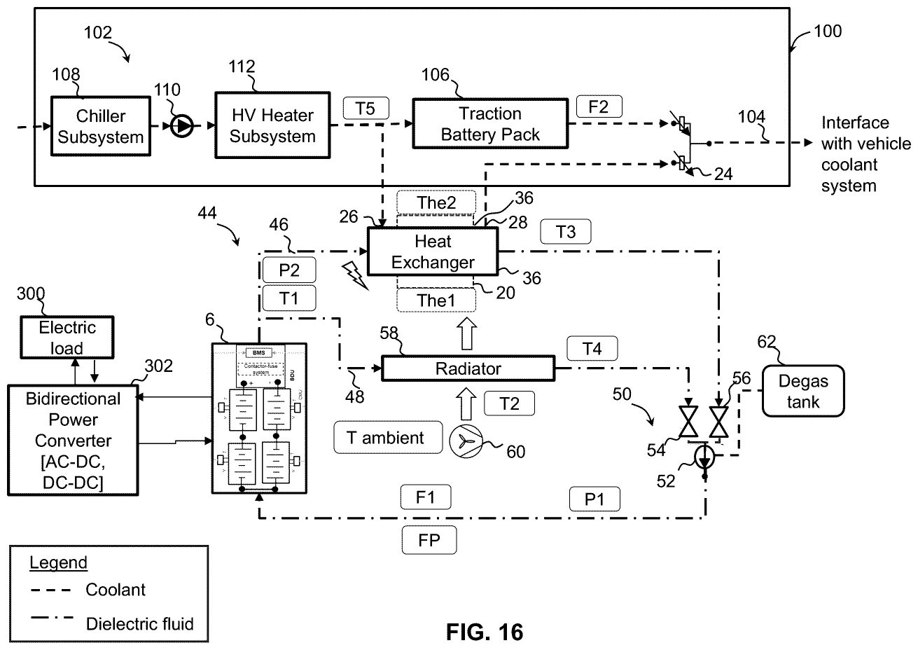

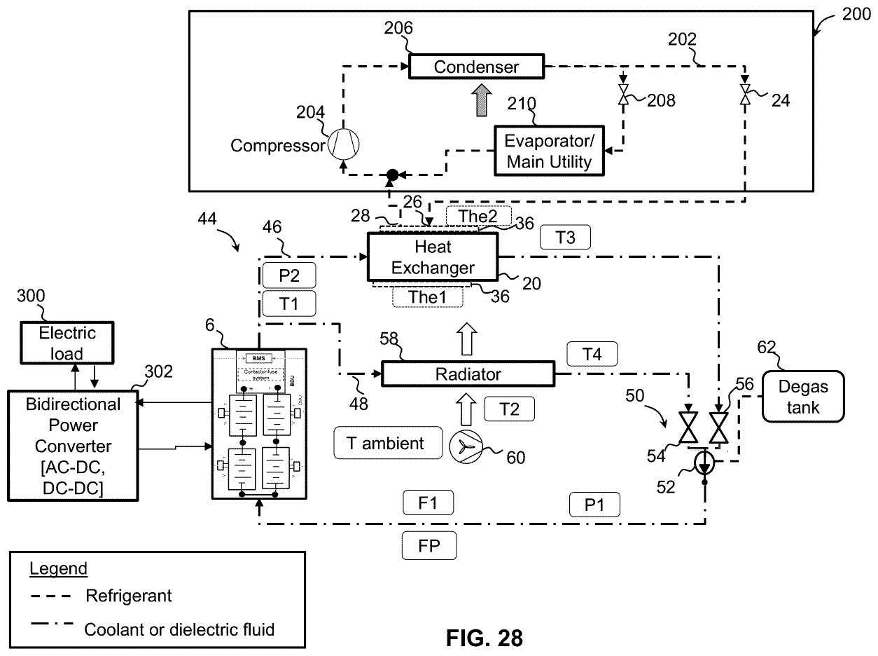

The power system 2 may be integrated with a thermal regulation subsystem. Examples of the thermal regulation subsystem are shown in FIGS. 16 and 28 in the form of a thermal management subsystem 102 for a traction battery pack 106 of an electric vehicle 100 (FIG. 16) and a refrigeration subsystem 200 (FIG. 28) as subsequently described. The thermal regulation subsystem includes a first heat transfer fluid flow loop such as first heat transfer fluid flow loop 104 for transporting coolant (FIG. 16) or first heat transfer fluid flow loop 202 for transporting a refrigerant (FIG. 28).

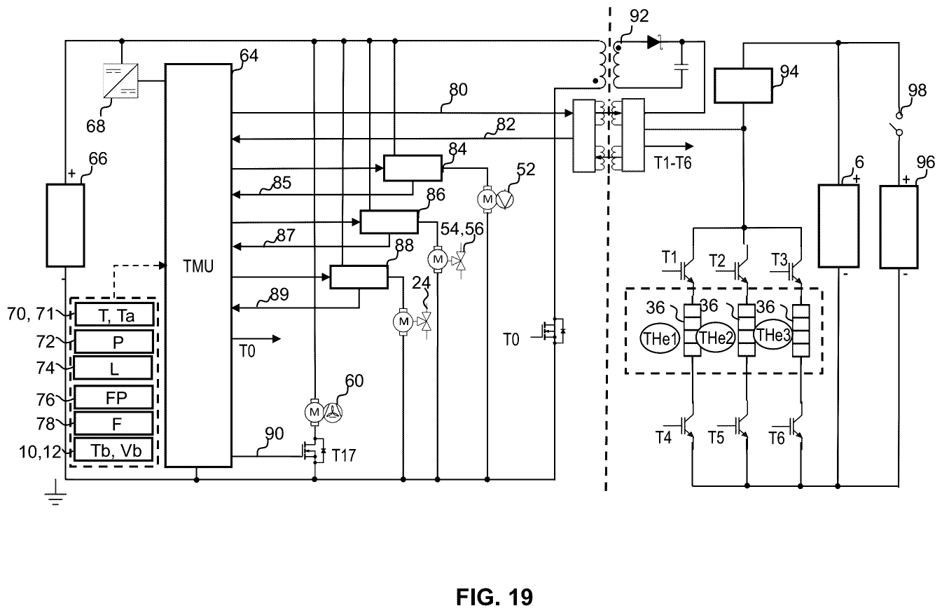

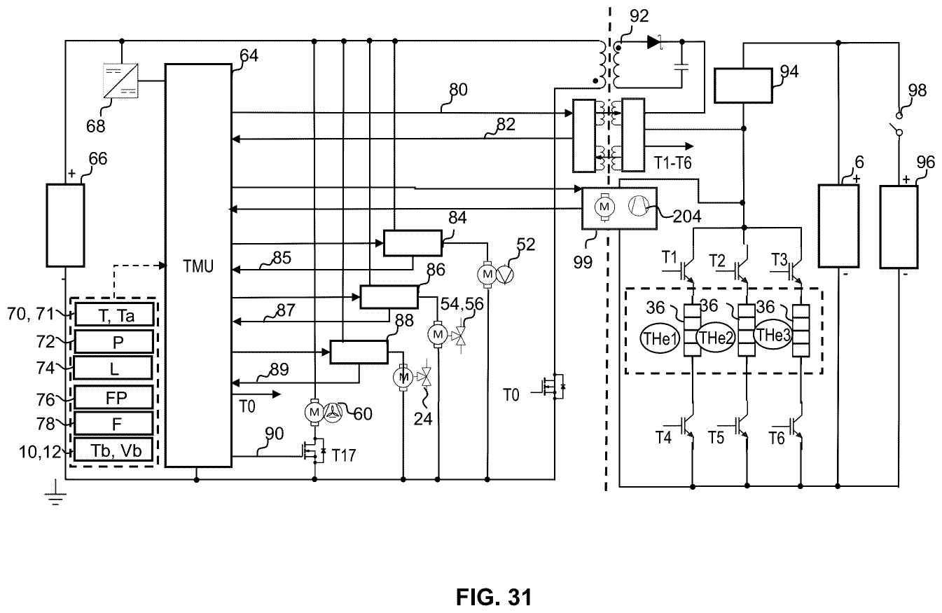

In the embodiment shown in FIGS. 1, 3, and 10, the power system 2 includes at least one battery pack 6 (in this embodiment, the battery pack 6 is formed from four modules of battery cells), a temperature sensor 10 for monitoring the temperature of the battery pack 6 (FIG. 10), a heat exchanger 20 and an associated first heat transfer fluid valve 24 (FIG. 3), a second heat transfer fluid flow path 44 (FIG. 3) for transporting a second heat transfer fluid therethrough associated with a pump 52 and at least one second heat transfer fluid valve 54, 56 (FIG. 3), at least one radiator 58 associated with at least one fan 60 position to blow air through the radiator 58 (in FIG. 1, there are two fans 60 associated with one radiator 58), and a thermal management unit 64 (FIGS. 1, 3 and 10). An expansion tank 62 (FIGS. 1 and 3) is connected to the second heat transfer fluid flow path 44 to allow for thermal expansion of the second heat transfer fluid and degassing of gas that may evolve from the second heat transfer fluid flow path 44 to avoid excessive pressure in the second heat transfer fluid flow path 44. A housing 4 (FIG. 1) contains the foregoing components of the power system 2, other than part of the radiator 58 and the fans 60 that are exposed outside of the housing 4. Electrical high voltage (HV) leads 14 (FIG. 1) are connected to the battery pack 6 for connection to an electrical load 300 (FIGS. 16 and 28). A low voltage (LV) connector 18 external to the housing 4 is used to connect another power source (e.g., grid power or another battery pack) for supplying electrical power to electrical components of the power system 2 such as the thermal management unit 64, heating elements 36 (FIG. 3) (if present) of the heat exchanger 20, the pump 52, the fan 60, and electrically-powered control interfaces for them (subsequently described with reference to FIGS. 19 and 31). An inlet connection 30 (e.g., threaded pipe or other connection type) and an outlet connection 32 (e.g., threaded pipe or other connection type) (FIG. 1) extend outside of the housing 4 and are connected by conduits (not shown) inside the housing 4 to an inlet 26 and an outlet 28 (FIGS. 1 and 3), respectively, of a heat exchanger first flow path 22 (FIG. 3) for transporting the first heat transfer fluid therethrough. The inlet connection 30 and the outlet connection 32 are used for connection to a first heat transfer fluid flow loop of a thermal regulation subsystem.

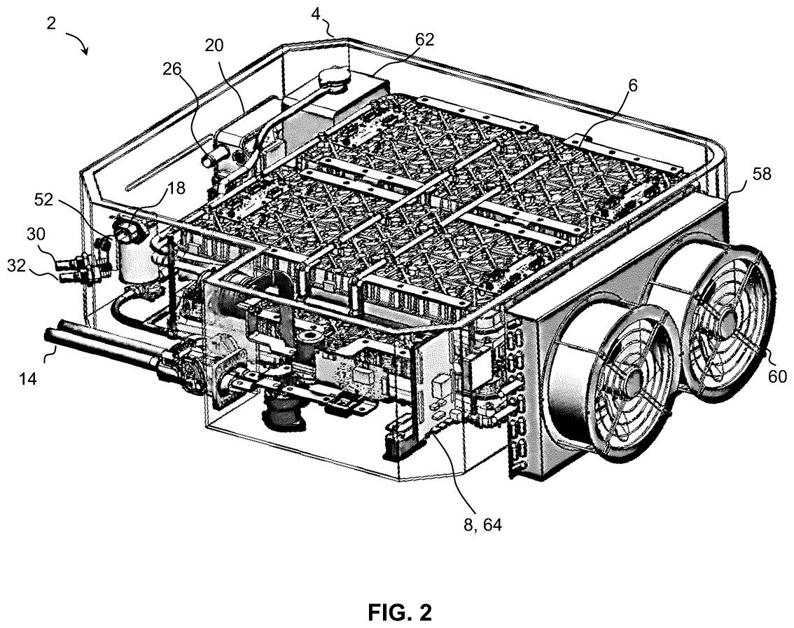

FIG. 2 shows another embodiment of a power system 2 similar to the embodiment shown in FIG. 1. In the embodiment of FIG. 1, the radiator 58 and fans 60 are positioned on the top of the housing 4, whereas in the embodiment of FIG. 2, the radiator 58 and fans 60 are positioned on the side of the housing 4 for a lower profile design.

The constituent components of the power system 2 are further described.

### Battery Pack, Second Heat Transfer Fluid, and Associated Sensors

Referring to FIG. 3, the battery pack 6 is used to provide electrical power to an electrical load 300, such as shown in FIGS. 16 and 28, with a bidirectional power converter 302 (e.g., a bidirectional alternating current (AC) to direct current (DC) converter) mediating electrical current between the electrical load 300 and the battery pack 6. The present disclosure is not limited by the nature of the electrical load 300 to which the battery pack 6 may be applied. As a non-limiting example, in FIG. 16, the battery pack 6 may serve as an auxiliary battery pack to extend the range of a traction battery pack 106 of the electric vehicle 100 or used to power electrical accessories of the electric vehicle 100. As another non-limiting example, in FIG. 28, the battery may serve as a power bank for a building or a mobile unit that has the refrigeration subsystem 200.

The battery pack 6 is associated with a second heat transfer fluid that is used to dissipate heat from the battery cells of the battery pack 6. For example, in embodiments, the battery pack 6 may be an immersion-cooled battery pack 6 and the second heat transfer fluid may be a dielectric fluid (e.g., a synthetic dielectric oil). In other embodiments, the battery pack 6 may be a liquid indirect-cooled battery pack 6, and the second heat transfer fluid may be a coolant (e.g., ethylene glycol and/or water).

The battery pack 6 is associated with one or more temperature sensors 10 (FIG. 10) for monitoring the temperature of the battery pack 6. The battery pack 6 may also be associated with one or more voltage sensors 12 (FIG. 10) for monitoring the voltage of the battery pack 6. The temperature sensors 10 and voltage sensors 12 may be interconnected with a battery management system 8 (BMS) (FIG. 10), which is a processor programmed to monitor thermal and electrical status of the battery pack 6. Implementations of the temperature sensors 10, voltage sensors 12 and battery management system 8 of the battery pack 6 are known in the art and are not described in detail herein.

Heat Exchanger with Optional First Heat Transfer Fluid Valve and with Optional Electrically-Powered Heating Element

Referring to FIG. 3, the heat exchanger 20 is used to transfer heat between the first heat transfer fluid associated with the thermal regulation subsystem (e.g., the coolant of the thermal regulation subsystem 102 in FIG. 16, or the refrigerant of the refrigeration system 200 in FIG. 28) and the second heat transfer fluid (e.g., a dielectric fluid or a coolant) associated with the battery pack 6.

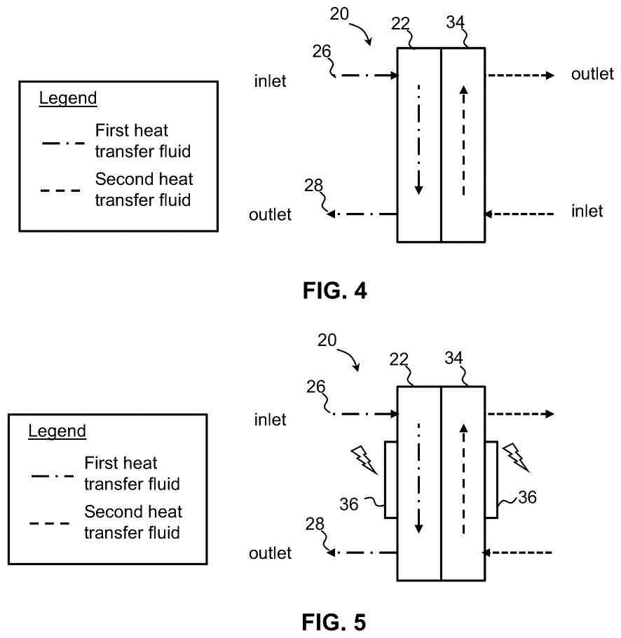

FIG. 4 is schematic depiction of a heat exchanger 20 of the power system 2 of FIG. 3. The heat exchanger 20 defines a heat exchanger first flow path 22 that extends from an inlet 26 for connection to the first heat transfer fluid flow loop 104 (FIG. 16) or 202 (FIG. 28) to receive the first heat transfer fluid from the first heat transfer fluid flow loop, to an outlet 28 for connection with the first heat transfer fluid flow loop to discharge the first heat transfer fluid to the first heat transfer fluid flow loop. The inlet 26 and outlet 28 of the heat exchanger first flow path 22 may be configured for removable connection (e.g., a threaded connection or other connection via inlet connection 30 and outlet connection 32, respectively) to terminals of the first heat transfer fluid flow loop, or may be configured for non-removable connection thereto (e.g., a welded or bonded connection, or by being integrally formed with conduits defining the first heat transfer fluid flow loop).

Referring to FIG. 3, the heat exchanger 20 may be optionally associated with a first heat transfer fluid valve 24. The first heat transfer fluid valve 24 is actuatable to selectively allow or prevent flow of the first heat transfer fluid through the heat exchanger first flow path 22. Control of flow of the first heat transfer fluid through the heat exchanger first flow path 22 may be used to implement different operating modes of the power system 2, as subsequently described. In the embodiment of FIG. 3, the first heat transfer fluid valve 24 is connected upstream of the inlet of the heat exchanger first flow path 22. In other embodiments, the first heat transfer fluid valve 24 may be disposed between the inlet and outlet of the heat exchanger first flow path 22, or downstream of the outlet of the heat exchanger first flow path 22.

Referring to FIG. 4, the heat exchanger 20 also defines a heat exchanger second flow path 34 in thermal communication with the heat exchanger first flow path 22. The heat exchanger second flow path 34 forms part of the heat exchanger-inclusive flow loop 46 (FIG. 3, as subsequently described) of the second heat transfer fluid flow path 34 for transporting the second heat transfer fluid therethrough.

The heat exchanger 20 may have various forms. As non-limiting examples, the heat exchanger 20 may be a stacked plate heat exchanger that defines fluid flow passages a plurality of plates, a double-pipe heat exchanger having an inner pipe disposed within an outer pipe, or a shell-and-tube heat exchanger having a bundle of tubes disposed in a shell.

Referring to FIGS. 3 and 5, the heat exchanger 20 may optionally have one or more electrically-powered heating elements 36 (shown in dashed line in FIG. 3) in thermal communication with the heat exchanger first flow path 22 and the heat exchanger second flow path 34, by mechanical and thermal bonding with the heat exchanger 20. FIG. 5 is schematic depiction of a heat exchanger 20 with electrically-powered heating elements 36 that may be used in the power system 2 of FIG. 3. The heating elements 36 may be powered by the battery pack 6 or a different battery pack (e.g., when the power system 2 is integrated with an electrical vehicle or mobile unit) or by connection to grid power (e.g., when the power system 2 is integrated in a building) such as via a charger 96 (see FIGS. 19 and 31). As a non-limiting example, the heating elements 36 may have a voltage rating of 400 volts or 800 volts, and be capable of heating to a maximum temperature of about 100° C.

Embodiments of heat exchangers 20 with electrically-powered heating elements 36 suitable for use in the power system 2 are disclosed in International Patent Application Publications no. WO 2023/060352 A1 (“Coolant-Refrigerant Heat Exchanger and Thermal Management System” to Litens Automotive Partnership published Apr. 20, 2023) and no. WO 2024/092359 A1 (“Coolant-Refrigerant Heat exchanger 20 with Induction Heater and Thermal Management System” to Litens Automotive Partnership published May 10, 2024), the entire contents of which are incorporated by reference herein. As noted in the foregoing publications, the electrically-powered heater may be an electrical resistance heater (e.g., a positive temperature coefficient (PTC) heater), an induction heater (e.g., an induction coil), an infrared heater, a microwave heater, or any other kind of heater.

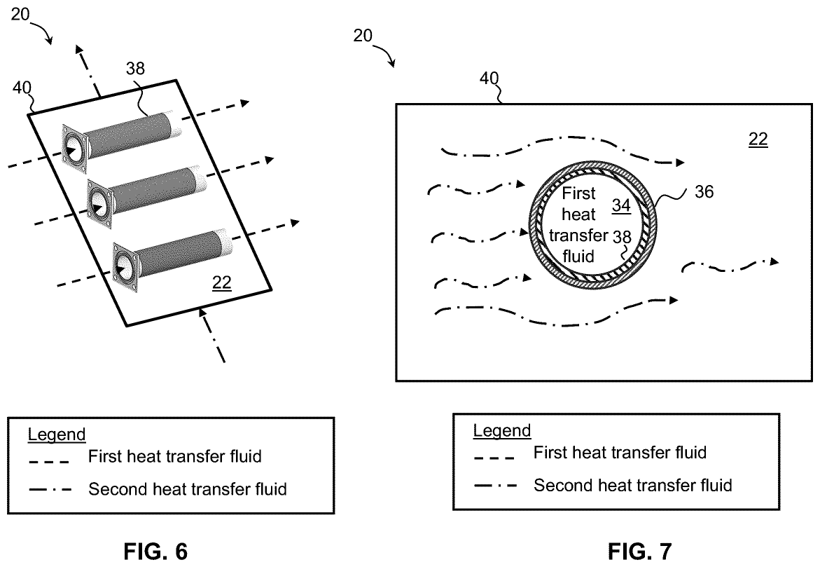

FIG. 6 is a schematic depiction of an embodiment of a tubular heat exchanger 20 with an electrically-powered heating elements 36 that may be used in the power system 2 of FIG. 3. FIG. 7 is a schematic depiction of one of the tubes 38 in a vessel 40 of the tubular heat exchanger 20 of FIG. 6. The tubular heat exchanger 20 has a plurality of tubes 38 disposed in a vessel 40. This type of heat exchanger 20 may advantageously provide for a low pressure drop. In FIGS. 6 and 7, the first heat transfer fluid flows through the tubes 38 and the second heat transfer fluid flows through the vessel 40, but this relationship may be reversed. The electrically-powered heating elements 36 are in the form a film resistor (e.g., a thick film of resistive mixture of glass and electrically conductive materials; or a carbon-based thin film resistor) that is printed or otherwise applied to the outer surface of each of the tubes 38. In this embodiment, the heating elements 36 are in direct contact with the second heat transfer fluid, which is possible if the second heat transfer fluid is a dielectric fluid.

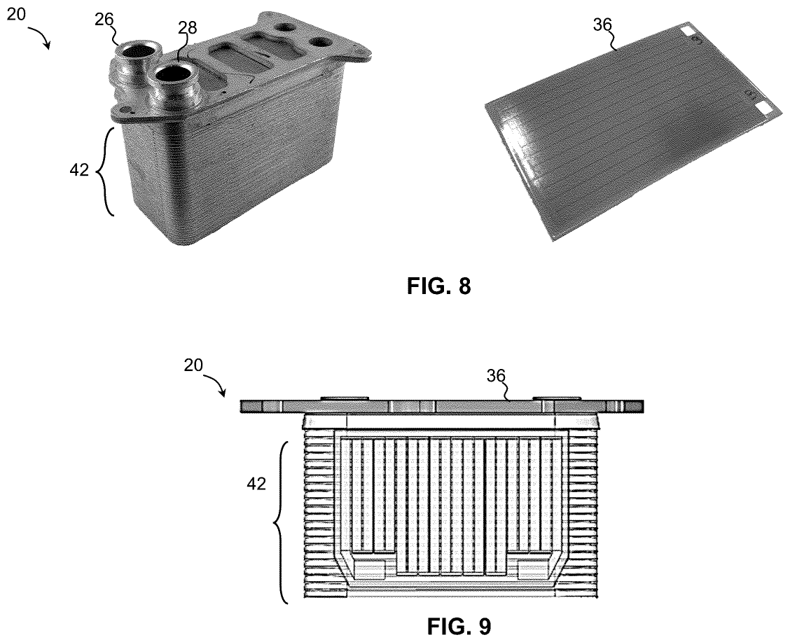

FIG. 8 is an exploded view of a stacked plate heat exchanger 20 with an electrically-powered heating element 36 that may be used in the power system 2 of FIG. 3. FIG. 9 is a side elevation, partial cut-away view of the stacked plate heat exchanger 20 of FIG. 8. The stacked plate heat exchanger 20 has a stack of separated plates 42 that define fluid flow passages therebetween, each of which are alternately in fluid communication with the inlet 26 for the first heat transfer fluid, or the inlet for the second heat transfer fluid. The heating element 36 in the form of a thick film resistor (e.g., a thick film of resistive mixture of glass and electrically conductive materials) that is soldered to a frame that terminates the stack of plates 42 of the heat exchanger 20.

### Second Heat Transfer Fluid Flow Path, Pump, Second Heat Transfer Fluid Valve, Radiator and Fan

Referring to FIG. 3, the power system 2 has a second heat transfer fluid flow path 44 for transporting a second heat transfer fluid therethrough. The second heat transfer fluid flow path 44 has a heat exchanger-inclusive flow loop 46 and a heat exchanger-exclusive flow loop 48. The heat exchanger-inclusive flow loop 46 includes the battery pack 6 and the heat exchanger second flow path 34. In the embodiment of FIG. 3, the heat exchanger-inclusive flow loop 44 is defined by the path including, in sequence, the battery pack 6, the second flow path of the heat exchanger 20, and the valve 56 and pump 52 of the three-way valve and pump assembly 50. In the embodiment of FIG. 3, the heat exchanger-exclusive flow loop 48 is defined by the path including, in sequence, the battery pack 6, the radiator 58, and the valve 54 and pump 52 of the three-way valve and pump assembly 50. In this embodiment, portions of the heat exchanger-inclusive flow loop 46 and the heat exchanger-exclusive flow loop 48 are defined in part by common conduits. In other embodiments, the heat exchanger-inclusive flow loop 46 and the heat exchanger-exclusive flow loop 48 may be defined by entirely mutually exclusive conduits.

The three-way valve and pump assembly 50 has a pump 52 that is used to pressurize the heat transfer liquid through the second heat transfer fluid flow path 44, whether it be through the heat exchanger-inclusive flow path 46 or the heat exchanger-exclusive 48 flow path. In embodiments, a suitable pump 52 is the Litens eAX™ electric pump (Litens Automotive Group; Vaughan, Canada).

At least one second heat transfer fluid valve is actuatable to configure the second heat transfer fluid flow path 44 selectively in a heat exchanger-inclusive state, and a heat exchanger-exclusive state. In the heat exchanger-inclusive state, the second heat transfer fluid is flowable through the heat exchanger-inclusive flow loop 46, but not the heat exchanger-exclusive flow loop 48. In contrast, in the heat exchanger-exclusive state, the second heat transfer fluid is flowable through the heat exchanger-exclusive flow loop 48, but not the heat exchanger-inclusive flow loop 46. Selective control of flow of the second heat transfer fluid through the heat exchanger-inclusive flow loop 46 and the heat exchanger-exclusive flow loop 48 may be used to implement different operating modes of the power system 2, as subsequently described. In the embodiment of FIG. 3, the at least one second heat transfer fluid valve is provided in the form of the three-way valve and pump assembly 50, including valves 54 and 46, and a third valve (not shown) directly associated with the pump 52. The heat exchanger-inclusive state is implemented by closing valve 54, while opening valve 56 and the valve associated with the pump 52. The heat exchanger-exclusive state is implemented by opening valve 54, while closing valve 56 and opening the valve associated with the pump 52. In embodiments, the at least one second heat transfer fluid valve may be implemented by the Litens MiniHub™ three-way valve assembly (Litens Automotive Group; Vaughan, Canada). In other embodiments, the at least one second heat transfer fluid valve may be implemented by one or more valves, depending on the configuration of the heat exchanger-inclusive flow loop 46 and the heat exchanger-exclusive flow loop 48.

In the embodiment of FIG. 3, the heat exchanger-exclusive flow loop 48 includes the radiator 58. The radiator 58 is optional, and may be absent from the heat exchanger-exclusive flow loop 48 in other embodiments. In embodiments where the radiator 58 is present, the fan 60 is positioned to blow air through the radiator 58 to dissipate heat from the second heat transfer fluid flowing therethrough. The radiator 58 and fan 60 may be used to cool the second heat transfer fluid in the passive cooling operating mode of the power system 2, as subsequently described. In the embodiment shown in FIG. 1, the fan 60 is implemented by a revolving blade, axial-flow fan 60 within a casing. In other embodiments, other types of fans 60 (e.g., a centrifugal fan 60) may be used.

In the embodiment of FIG. 3, the power system 2 has one heat exchanger-exclusive flow loop 48. In other embodiments, the power system 2 may have more than one heat exchanger-exclusive flow loop 48 arranged in parallel with each other. Each of the heat exchanger-exclusive flow loops 48 may include a radiator 58 with an associated fan 60.

### Sensors and Thermal Management Unit

One or more sensors are used in conjunction with the thermal management unit 64 to monitor one or more operating parameters of the power system 2, and control components of the power system 2 to implement different operating modes of the power system 2.

Referring to the embodiment of FIG. 3, the power system 2 may be provided with temperature sensors (labeled “T1” through “T4”), pressure sensors (labelled “P1” and “P2”), a flow rate sensor labelled “F1”, and a fluid property sensor labelled “FP” to measure the temperature, pressure, flow rate, fluid property, respectively, of the second heat transfer fluid at different locations of the second heat transfer fluid flow path 44. The temperature sensors may also include an ambient temperature sensor, Ta, for measuring temperature of air surrounding the power system 2. Further, each of the heating elements 36 (if present) of the heat exchanger may be provided with a temperature sensor, labelled as “The1” and “The2”. Referring to the embodiment of FIG. 10, the battery pack 6 is provided with at least one temperature sensor 10 and optionally at least one voltage sensor 12, which are interconnected with a battery management system 8 as previously described.

The thermal management unit 64 may use the temperature, pressure and flow rate of the second heat transfer fluid to detect unusual operating conditions such as a blockage in the second heat transfer flow path 44 or a change in properties of the second heat transfer fluid. The fluid property (FP) sensor may be used to monitor properties of the second heat transfer fluid such as density, dynamic viscosity and/or dielectric constant. These monitored properties may be used to infer the quality of the second heat transfer fluid and changes thereto. These monitored properties may also be used to confirm unusual operating conditions or changes in properties of the second heat transfer fluid that are detected by the thermal management unit 64 based on temperature, pressure and flow rate of the second heat transfer fluid. In embodiments where the second heat transfer fluid is a dielectric fluid used for immersion cooling of the battery pack 6, monitoring the dialect constant thereof can be used to check the electrical insulative properties of the dielectric fluid.

Referring to the embodiment of FIG. 10, the thermal management unit 64 includes a processor operatively connected to a memory. The processor is operatively connected to the temperature sensor 10 to receive temperature measurements of the battery pack 6, either directly or from the battery management system 8. The processor may also be operatively connected to the voltage sensor 12 for the battery pack 6, to the thermal, pressure and flow rate sensors to receive temperature, pressure, and flow rate measurements, respectively, of the second heat transfer fluid at different locations of the second heat transfer fluid flow path 44, to the ambient temperature sensor, and to the temperatures sensors associated with the heating elements 36 (if present). The processor is operatively connected to the valves of the power system 2 to actuate the valves (e.g., electrically actuated valves) of the power system 2 such as by opening or closing the valves or otherwise varying the flow orifice size of the valves; the valve actuation control is denoted “A-V1” through “A-Vn” for different valves in FIG. 10. The processor is operatively connected to the pump 52 to control the operating speed of the pump 52 such as by switching the pump 52 “on” or “off” or varying the current and/or voltage applied to the pump 52; the pump speed control is denoted “A-S1” in FIG. 10. In the embodiment of FIG. 28, the processor may similarly be operatively connected to the compressor 204 to control the speed of the pump of compressor 204; the compressor speed control is denoted “A-S2” in FIG. 10. The processor is operatively connected to the electrically-powered heating elements 36 of the heat exchanger 20 to control the heat output of the heating elements 36 such as by switching the heating elements 36 “on” or “off” or otherwise varying the power supplied to the heating elements 36; the heating element control is denoted “A-Q1” to “A-Qn” for different heating elements in FIG. 10. The processor is operatively connected to the fan 60 to control the activation of the fan 60 such as by switching the fan 60 “on” or “off” or controlling the current and/or voltage applied to the fan 60; the fan speed control is denoted “A-R1” in FIG. 10.

The memory includes a non-transitory computer readable medium that stores instructions that are executable by the processor to control components of the power system 2 that are operatively connected to the processor. In embodiments, the processor may execute the instructions stored by the memory to perform the following based at least on the temperature of the battery pack 6 detected by the temperature sensor 10: actuate the first heat transfer fluid valve 24 and the at least one second heat transfer fluid valve 54, 56; activate the electrically-powered heating element 36 of the heat exchanger 20; and activate the fan 60. The thermal management unit 64 performs such control to implement different operating modes of the power system 2, as subsequently described.

### Operating Modes of Power System

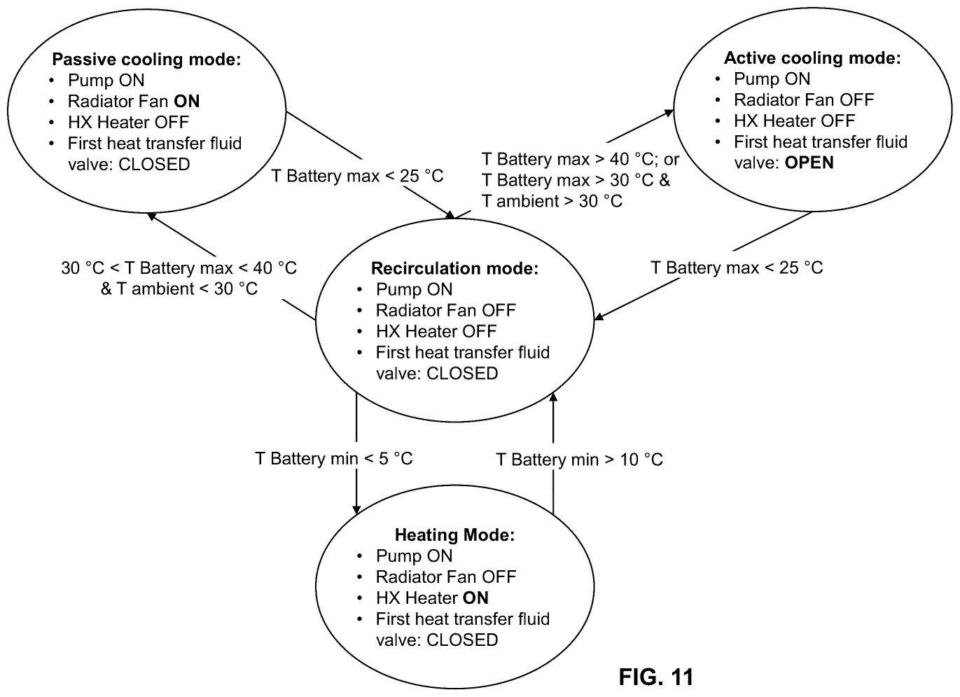

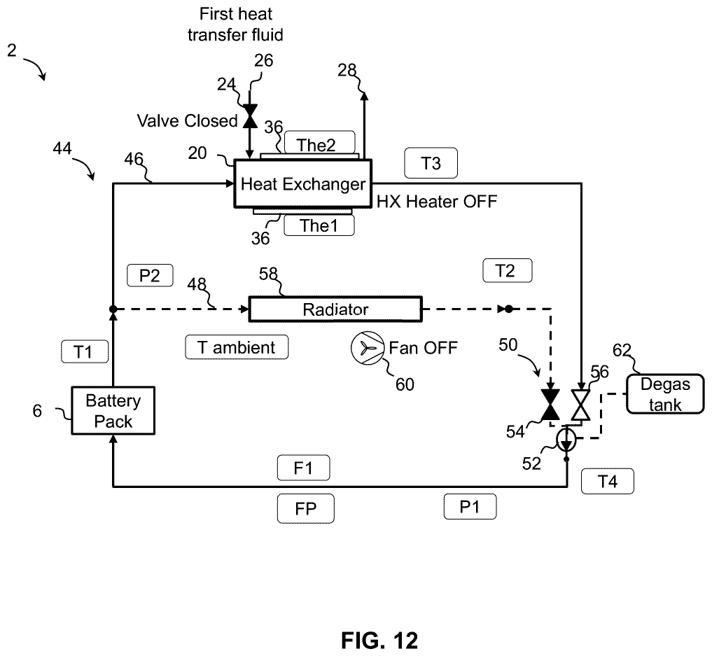

FIG. 11 is a state and mode diagram showing differing operational modes of the power system 2 of FIG. 3, in the embodiment in which the heat exchanger 20 includes an electrically-powered heating element 36. Based on a temperature measurement of the battery pack 6 by the temperature sensor 10, the thermal management unit 64 controls the components of the power system 2 as shown in FIG. 11, to configure the power system 2 in different operating modes as shown in FIGS. 12 to 15, with the objective of maintaining the battery pack 6 in an optimum temperature range (e.g., between 25° C. and 30° C.). In FIG. 11, the arrow lines between the operating modes indicate the thermal management unit 64 re-configuring the power system 2 from one operating mode to another operating mode. The temperature conditions imposed on the arrow lines indicate Boolean tests evaluated by the thermal management unit 64. If the test evaluates as “true”, then thermal management unit 64 reconfigures the power system 2 from the operating mode at the tail of the arrow line to the head of the arrow line. Thus, the state and mode diagram of FIG. 11 may be programmed as instructions by “if-then” statements stored in the memory and executable by the processor of the thermal management unit 64. In all operating modes, the pump 52 is turned “on” to pressurize the second heat transfer fluid through the second heat transfer flow path.

### Recirculation Mode

FIG. 12 shows the power system 2 configured in a recirculation mode which can be used when the battery pack 6 is operating in the optimum temperature range (e.g., between 25° C. and 30° C.). The recirculation mode can also be used upon start-up of the battery, when the battery pack 6 has not yet heated up to the desired operating temperature range, but when it is undesirable to turn on the heating elements 36 of the heat exchanger 20 or if there is insufficient electrical power to do so. In the recirculation mode, the first heat transfer fluid valve 24 is closed (as denoted by being shown with shading) to prevent flow of the first heat transfer fluid through the heat exchanger first flow path 22. The valve 56 is open (as denoted by being shown without shading) to permit flow (as denoted by the solid line) of the second heat transfer fluid through the heat exchanger-inclusive flow loop 46, while the valve 54 is closed (as denoted by being shown with shading) to prevent flow (as denoted by the dashed line) of the second heat transfer fluid through the heat exchanger-exclusive flow loop 48. The heating elements 36 of the heat exchanger 20 are turned “off”, and the fan 60 is turned “off”. When the battery pack 6 is connected to an external load 300 (FIGS. 16 and 28), the battery pack 6 will increase in temperature during operation towards the optimum temperature range. While the power system 2 is in the recirculation mode, the battery management system 8 and the thermal management unit 64 may communicate with each other to limit the permissible charging rate of the battery pack 6 to avoid degradation of the life of the battery pack 6.

### Passive Cooling Mode

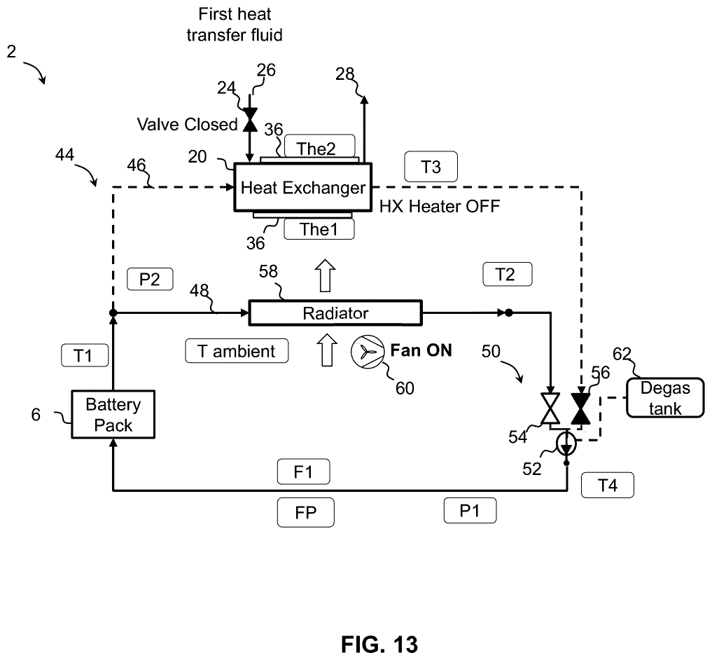

Referring to FIGS. 11 and 13, the thermal management unit 64 may configure the power system 2 in a passive cooling mode when the maximum temperature of the battery pack 6 exceeds a predefined passive cooling activation temperature (e.g., between 30° C. and 40° C.) and the ambient temperature is moderate or less than predefined ambient air temperature (e.g., less than 30° C.). These activation conditions for the fan 60 are non-limiting examples, and may be substituted or supplemented with another activation condition. In the passive cooling mode, the first heat transfer fluid valve 24 is closed to prevent flow of the first heat transfer fluid through the heat exchanger first flow path 22. The valve 56 is closed to prevent flow (as denoted by the dashed line) of the second heat transfer fluid through the heat exchanger-inclusive flow loop 46, while the valve 54 is open to allow flow (as denoted by the solid line) of the second heat transfer fluid through the heat exchanger-exclusive flow loop 48. The heating elements 36 of the heat exchanger 20 are turned “off”, and the fan 60 is turned “on”. The fan 60 blowing air through the radiator 58 cools the second heat transfer fluid. The speed of the fan 60 and the speed of the pump 52 may be adjusted to control the cooling rate of the second heat transfer fluid, and hence the cooling rate of the battery pack 6. When the maximum temperature of the battery pack 6 decreases to less than a predefined passive cooling deactivation temperature (e.g. less than 25° C.), the thermal management unit 64 configures the power system 2 in the recirculation mode (FIG. 12).

### Active Cooling Mode

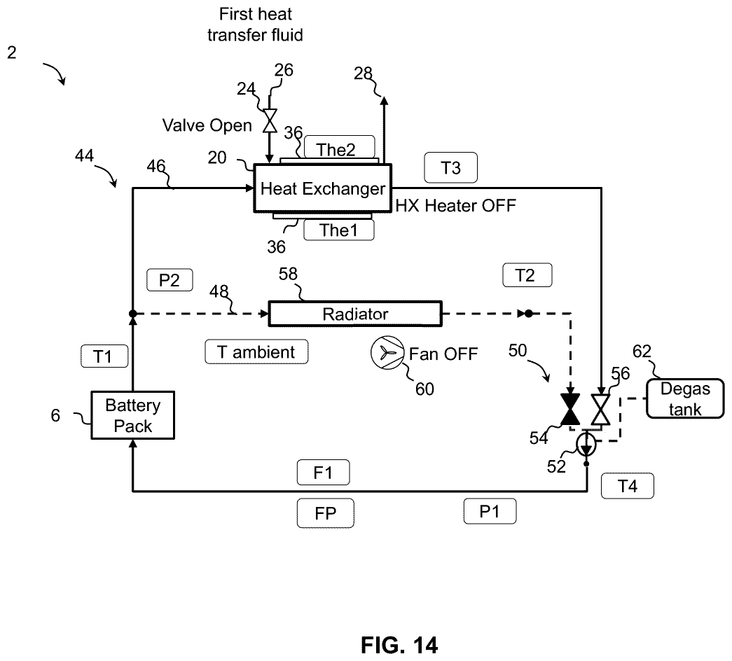

Referring to FIGS. 11 and 14, the thermal management unit 64 may configure the power system 2 in an active cooling mode when the maximum temperature of the battery pack 6 increases exceeds a predefined active cooling activation temperature (e.g., greater than 40° C.), or when the maximum temperature of the battery pack 6 increases exceeds a predefined active cooling activation temperature (e.g., greater than 30° C.) and the ambient temperature is high or greater than a predefined ambient air temperature (e.g., greater than 30° C.). These actuation conditions for actuating the first heat transfer fluid valve 24 to an open state are non-limiting examples, and may be substituted or supplemented with another actuation condition. In the active cooling mode, the first heat transfer fluid valve 24 is opened to allow flow of the first heat transfer fluid through the heat exchanger first flow path 22. The valve 56 is opened to allow flow (as denoted by the solid line) of the second heat transfer through the heat exchanger-inclusive flow loop 48, while the valve is 54 closed to prevent flow (as denoted by the dashed line) of the second heat transfer fluid through the heat exchanger-exclusive flow loop 48. The heating elements 36 of the heat exchanger 20 are turned “off”, and the fan 60 is turned “off”. The speed of the pump 52 may be adjusted to control the cooling rate of the second heat transfer fluid, and hence the cooling rate of the battery pack 6. Heat of the second heat transfer fluid is transferred via the heat exchanger 20 to the first heat transfer fluid. When the maximum temperature of the battery pack 6 decreases to less than a predefined active cooling deactivation temperature (e.g. less than 25° C.), the thermal management unit 64 configures the power system 2 in the recirculation mode (FIG. 12).

### Heating Mode

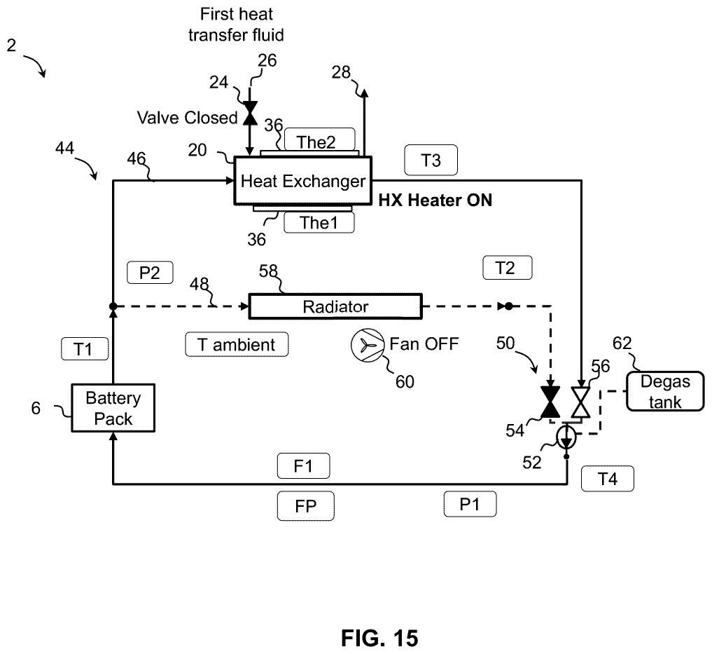

Referring to FIGS. 11 and 15, the thermal management unit 64 may configure the power system 2 in a heating mode when the minimum temperature of the battery pack 6 decreases to less than a predefined heating mode temperature (e.g., less than 5° C.). In the heating mode, the first heat transfer fluid valve 24 is closed to prevent flow of the first heat transfer fluid through the heat exchanger first flow path 22. (In other embodiments, the first heat transfer fluid valve 24 may be open to concurrently allow flow of the first heat transfer fluid through the heat exchanger first flow path 22 during the heating mode.) The valve 56 is opened to allow flow (as denoted by the solid line) of the second heat transfer through the heat exchanger-inclusive flow loop 46, while the valve 54 is closed to prevent flow (as denoted by the dashed line) of the second heat transfer fluid through the heat exchanger-exclusive flow loop 48. The heating elements 36 of the heat exchanger 20 are turned “on”, and the fan 60 is turned “off”. The speed of the pump 52 may be adjusted to control the heating rate of the second heat transfer fluid, and hence the cooling rate of the battery pack 6. Heat generated by the heating elements 36 of the heat exchanger 20 is transferred to the second heat transfer fluid flowing through the heat exchanger second flow path 34, which is then transferred to the battery pack 6. Heat may also be transferred from the first heat transfer fluid to the second heat transfer fluid via the heat exchanger 20. When the minimum temperature of the battery pack 6 increases to greater than a predefined heating deactivation temperature (e.g. greater than 10° C.), the thermal management unit 64 configures the power system 2 in the recirculation mode (FIG. 12). While the power system 2 is in the heating mode, the battery management system 8 and the thermal management unit 64 may communicate with each other to limit the permissible charging rate of the battery pack 6 to avoid degradation of the life of the battery pack 6.

### Passive Heating Mode and Additional Operating Modes

The configuration of the power system 2 in FIG. 14 is previously described as an active cooling mode because it is presumed that the temperature of the first heat transfer fluid flowing through the heat exchanger 20 is less than the temperature of the second heat transfer fluid flowing through the heat exchanger 20, such that the second heat transfer fluid is cooled when flowed through the heat exchanger 20. In contrast, if the temperature of the first heat transfer fluid flowing the heat exchanger 20 is greater than the temperature of the second heat transfer fluid flowing through the heat exchanger 20, then the second heat transfer fluid is heated when flowed through the heat exchanger 20. In this circumstance, the configuration of the power system 2 in FIG. 14 may be referred to as a passive heating mode, in distinction to the heating mode of FIG. 15.

The power system 2 of FIG. 3 may be configured in modes additional to those shown in FIGS. 11 to 15 by different combinations of actuation states of the valves (which may range from fully open to partially open to fully closed), activation states of the heating elements 36 (if present) of the heat exchanger 20 (which may range from “off” to an intermediate level of power to a maximum level of power), and modulation of the speed of the pump 52 and the fan 60, as well as different relative temperatures of the first heat transfer fluid and the second heat transfer fluid.

Integration of Power System with Thermal Management Subsystem for Traction Battery Pack of an Electric Vehicle

FIG. 16 is a schematic depiction of the power system 2 of FIG. 3 when integrated with a thermal management subsystem 102 of an electric vehicle 100 used to regulate the temperature of the traction battery pack 106 of the electric vehicle 100. In the embodiment shown in FIG. 16, the traction battery pack 106 is a liquid indirect-cooled battery pack and the first heat transfer fluid is a coolant fluid (e.g., ethylene glycol). The thermal management subsystem 102 of the electric vehicle 100 includes the first heat transfer fluid flow loop 104 (a portion of which is shown in FIG. 16) including a chiller subsystem 108, a pump 110, a high voltage heater subsystem 112, and heat transfer channels (not shown) in the traction battery pack 106 for transporting the first heat transfer fluid. FIG. 16 depicts a simplified arrangement of the thermal management subsystem 102 for illustrating the operating principle of the power system 2. The chiller subsystem 108 may itself comprise components (not shown) such as a compressor, a condenser, an expansion valve, a heat exchanger, and a dryer or separator, connected sequentially in a flow loop, as is known in the art and operate similarly to the refrigeration system of FIG. 28 which is subsequently described. The high voltage heater subsystem 112 may itself comprise components (not shown) such as a PTC heater, a reservoir, a heat exchanger and a pump, connected sequentially in a flow loop, as is known in the art.

The battery pack 6 of the power system 2 is connected to an electrical load 300 via an optional bidirectional power converter 302 (e.g., a bidirectional alternating current (AC) to direct current (DC) converter). As a non-limiting example, the battery pack 6 may be used extend the range of a main traction battery pack 106 of an electric vehicle 100 and as such may be connected to the traction motor as the electrical load 300. As another non-limiting example, the battery pack 6 may be connected to electrical accessories of the electric vehicle 100 as the electrical load 300. In the embodiment shown in FIG. 16, the battery pack 6 is an immersion-cooled battery pack and the first heat transfer fluid is a dielectric fluid. In other embodiments, the battery pack 6 may be a liquid indirect-cooled battery pack and the first heat transfer fluid may be a coolant fluid (e.g., ethylene glycol).

The power system 2 is integrated with the thermal management subsystem 102 by connecting the inlet 26 and the outlet 28 of the heat exchanger first flow path 22 to the first heat transfer fluid flow loop. In this embodiment, the inlet 26 of the heat exchanger first flow path 22 is connected to the first heat transfer fluid flow loop immediately upstream of the traction battery pack 106 so that, in the active cooling mode (FIG. 14), at least a portion of the first heat transfer fluid after flowing through the chiller subsystem 108 can be diverted to the first flow path of the heat exchanger 20 without having flowed through the traction battery pack 106. The outlet 28 of the heat exchanger first flow path 22 is connected to the first heat transfer fluid flow loop immediately downstream of the traction battery pack 106 so that, in the active cooling mode (FIG. 14), the portion of first heat transfer fluid that is heated by the second heat transfer fluid in the heat exchanger 20 is not flowed directly through the traction battery pack 106. In other embodiments, the inlet and outlet of the heat exchanger 20 flow first flow path may be connected to different locations of the first heat transfer fluid flow path 104.

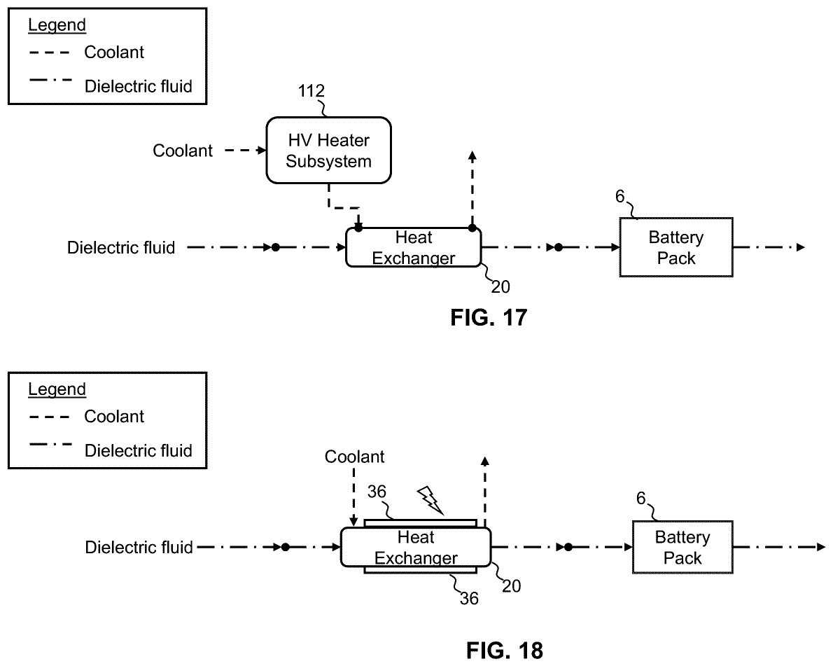

FIGS. 17 and 18 are schematic depictions of the heat transfer in the heat exchanger 20 of the power system 2 integrated with the thermal management subsystem 102 as in FIG. 16, for the embodiment of the power system 2 in which the heat exchanger 20 of the power system 2 does not include an electrically-powered heating element 36 (FIG. 17) and for the embodiment of the power system 2 in which the heat exchanger 20 of the power system 2 includes an electrically-powered heating element 36 (FIG. 18). In FIGS. 17 and 18, the power system 2 may be in the active cooling mode as shown in FIG. 14. Comparing FIGS. 17 and 18, the provision of a heat exchanger 20 with heating elements 36 (FIG. 18) advantageously allows for heating of the second heat exchange fluid independently of the high voltage heater subsystem 112 of the electric vehicle 100.

FIG. 19 is a schematic diagram for an embodiment of a control architecture for the power system of FIG. 3 for integration with a thermal management subsystem as in FIG. 16.

In the embodiment shown in FIG. 19, a low voltage battery 66 is used to supply electrical power, mediated by a DC-DC converter 68 (e.g., low-dropout regulator or a buck converter), to the thermal management unit 64, as well as to a pump control interface 84, valve control interfaces 86 and 88, and the fan 60. The low voltage battery 66 is optional, and may be absent from the power system 2. Instead of using the low voltage battery 66, a power source connected to the low voltage connector 18 (FIG. 1) may be used to supply power to the aforementioned components. If the low voltage battery 6 and the low voltage connector 18 are both present, then the low voltage connector 18 may also be used to connect a power source to the low voltage battery 66 to charge the low voltage battery 66.

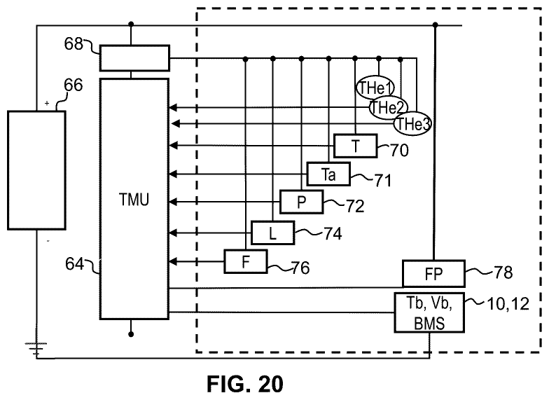

FIG. 20 shows the interface between the thermal management unit and sensors of the control architecture of FIG. 19. One or more temperature sensors (T) 70, pressure sensors 72, level sensors 74, fluid property sensors (FP) 76, and flow sensors 78 are operatively connected to the thermal management unit 64 to communicate measurements of temperature, pressure, fluid level, fluid properties (e.g., density, dynamic viscosity and/or dielectric constant) and flow rate at different locations of the second heat transfer fluid flow path to the thermal management unit 64. One or more ambient temperature sensors (Ta) 71 for measuring ambient temperature are operatively connected to the thermal management unit 64 to communicate ambient air temperature measurements to the thermal management unit 64. One or more temperature sensors (Tb) 10 and voltage sensors (Vb) 12 are operatively connected, optionally via the battery management system 8 of the battery pack 6, to communicate temperature and voltage measurements, respectively, of the battery pack 6 to the thermal management unit 64. One or more temperature sensors (The1 to The3) are operatively connected to communicate temperature measurements of the heating elements 36 of the heat exchanger 20 to the thermal management unit 64.

In FIG. 19, a high voltage battery charger 96 for the battery pack is connected, via a switch 98, to supply electrical power to the battery pack 6 for charging the battery pack 6. A grid power supply (not shown) may be used to supply AC electrical power, mediated by an AC-DC converter (not shown), to the battery charger 96. Alternatively, a power supply (not shown) may be used to supply DC power, mediated by a DC-DC converter (not shown), to the battery charger 96. The switch 98 may be controlled by the thermal management unit 64 to limit the charging rate of the battery pack 6, such as when the power system 2 is in the recirculation mode or the heating mode, as previously described.

In FIG. 19, the thermal management unit 64 is operatively connected via a forward control path 80 and a feedback path 82 to a transformer 92 to a control interface for the heating elements 36 of the heat exchanger 20, to control the heat output of the heating elements 36. In this embodiment, the control interface for controlling the heating elements includes transistors (T1 to T6) that are used to switch the heating elements 36 “on” or “off”, and or to implement pulse-width modulation (PWM) control over the heating elements 36. In this embodiment, the battery pack 6 supplies electrical power, mediated by a DC-DC converter 94 (e.g., a single-ended primary-inductor converter (SEPIC)) to the heating elements 36.

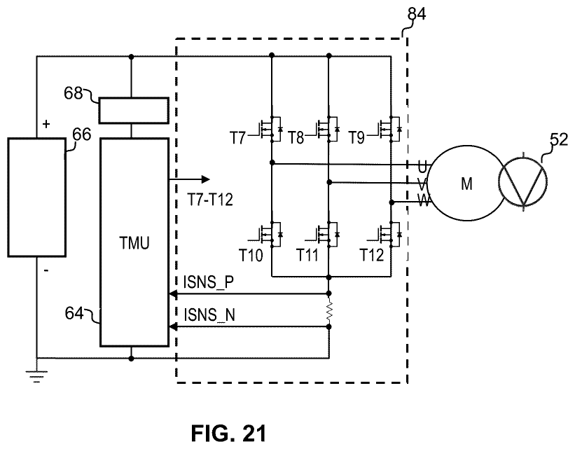

In FIG. 19, the thermal management unit 65 is operatively connected by a forward control path 80 and a feedback path 82 to a pump control interface 84 to control the speed of a motor of the pump 52. FIG. 21 shows the thermal management unit 64 connected to an embodiment of the pump control interface 84. In this embodiment, the pump control interface 84 includes transistors (T7 to T12) that are used to switch a motor of the pump 52 “on” or “off” and/or to implement pulse-width modulation (PWM) control over the motor of the pump 52. In other embodiments (not shown), the pump control interface 84 may be implemented by software and hardware elements, such as those known in the art of supervisory control and data acquisition (SCADA) control systems.

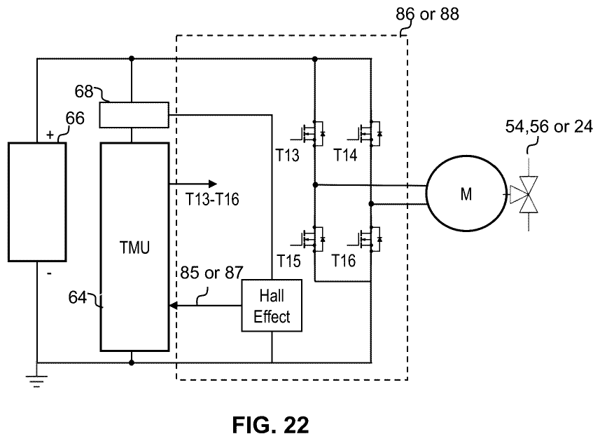

In FIG. 19, the thermal management unit 64 is operatively connected by a forward control path and a feedback path 85 to a valve control interface 86 for second heat transfer fluid valves 54, 56, to control the actuation of the second heat transfer fluid valves 54, 56. Similarly, the thermal management unit 64 is operatively connected by a forward control path and a feedback path 87 to a valve control interface 88 for first heat transfer fluid valve 24 to control the actuation of first heat transfer fluid valves 24. FIG. 22 shows the thermal management unit 64 connected to an embodiment of the valve control interface 86 or 88. In this embodiment, the valve control interface 86 or 88 includes transistors (T13 to T16) that are used to control a motor associated with the valve 54, 56 or 24 to actuate the valve between “closed” or “open” states or an intermediate state. The feedback path 85 or 87 includes a Hall effect sensor for sensing of the actuation state of valves. In other embodiments (not shown), the valve control interface 86 or 88 by software and hardware elements to actuate the valves 54, 56 or 24, such as those known in the art of supervisory control and data acquisition (SCADA) control systems.

In FIG. 19, the thermal management unit 64 is operatively connected by a control path 90, via a transistor (T17), to control a speed of a motor of the fan 60 associated with the radiator 58. The transistor (T17) is used to switch the motor of the fan 60 “on” or “off” and/or to implement pulse-width modulation (PWM) control over the motor of the fan 60.

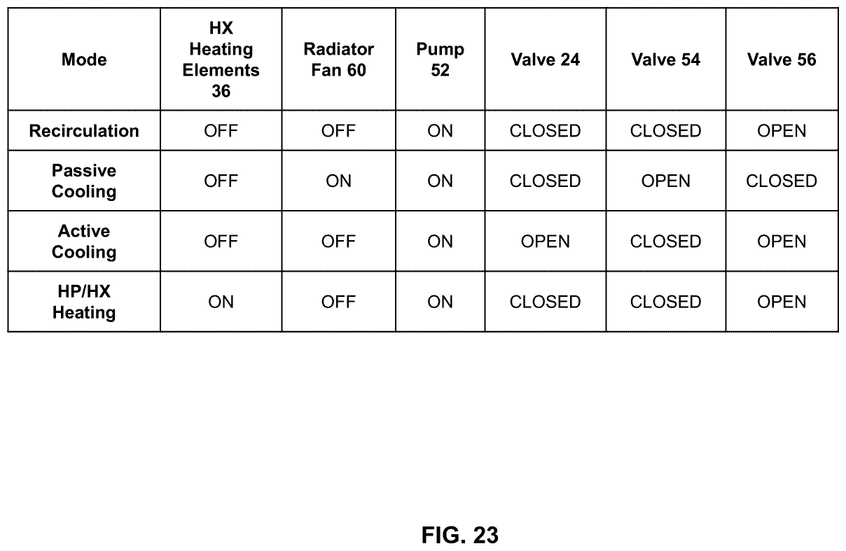

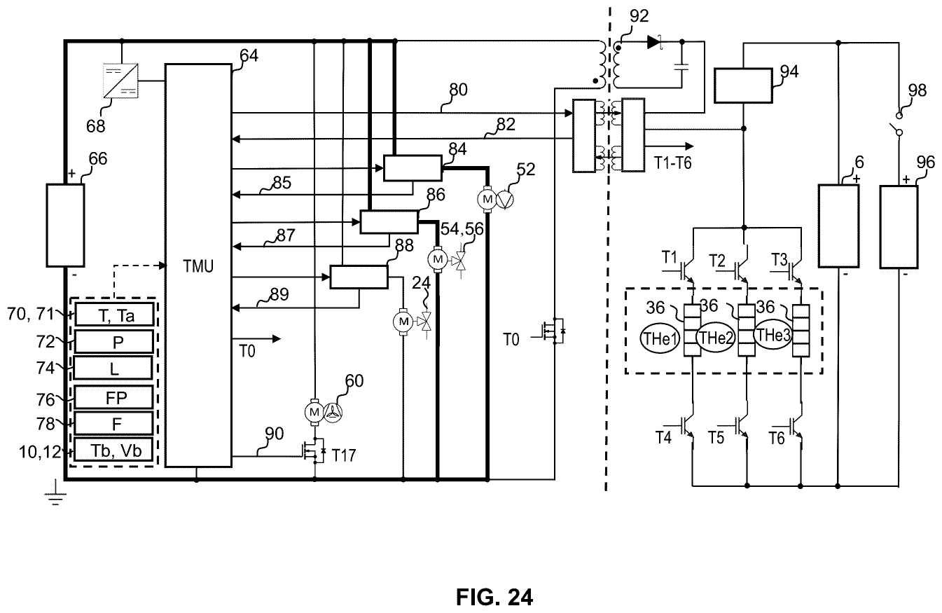

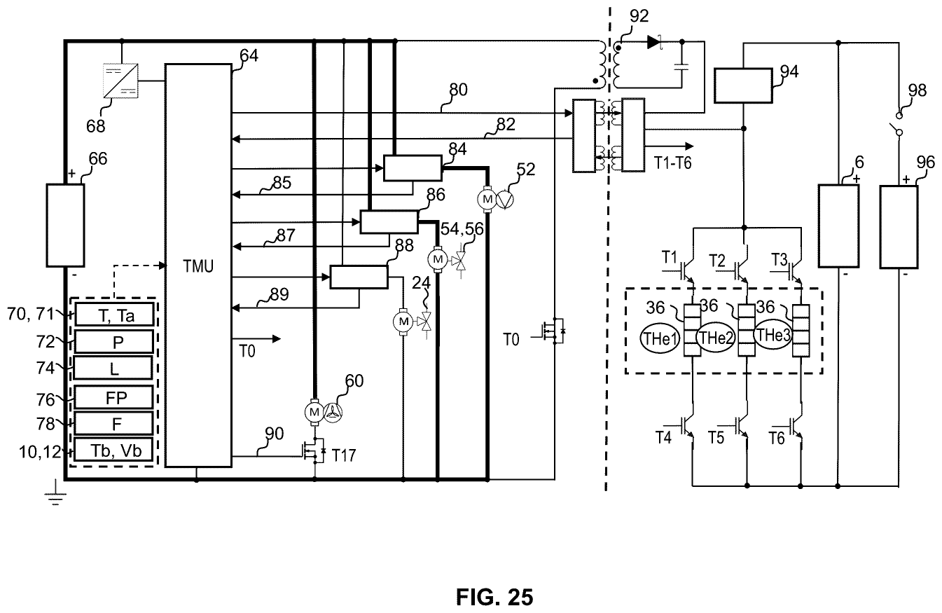

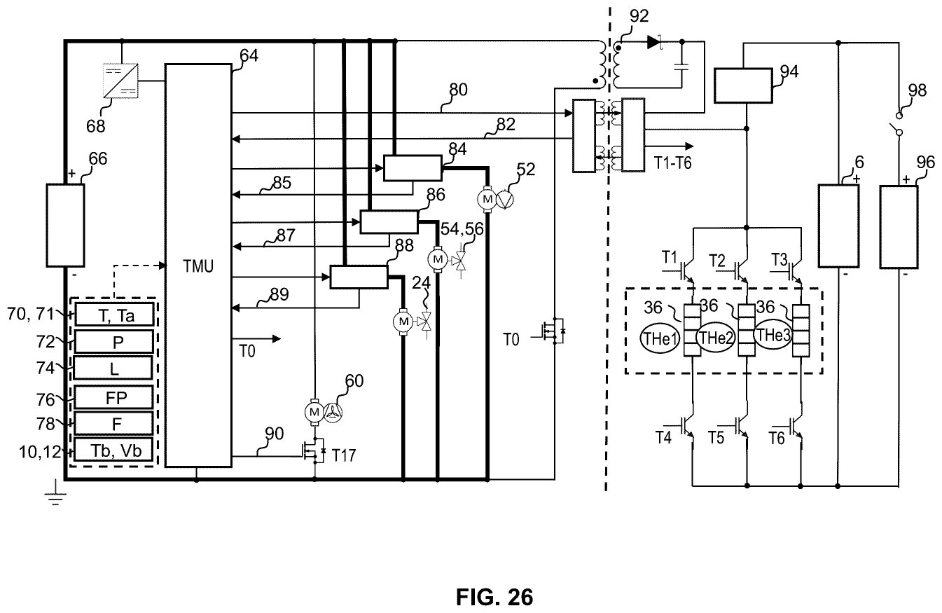

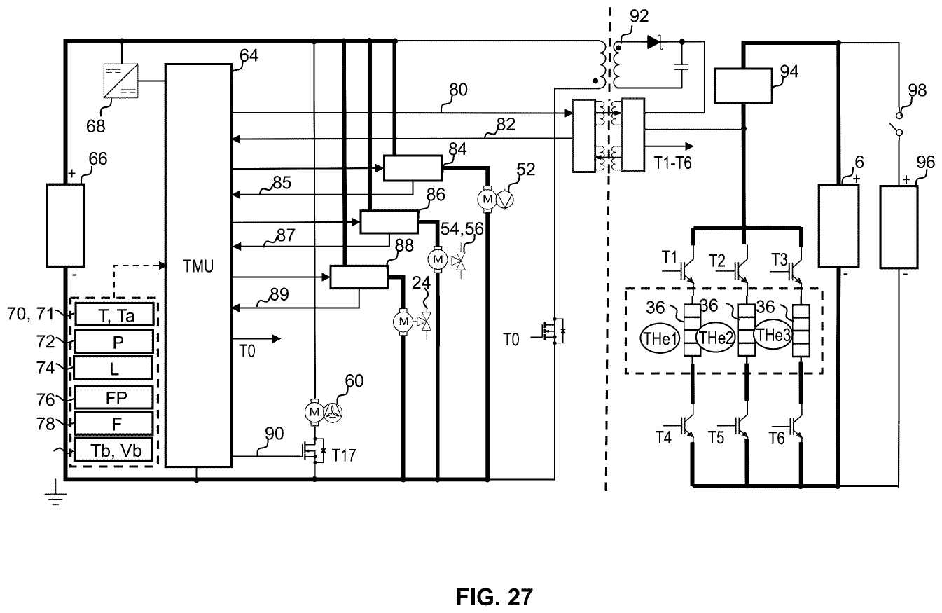

FIG. 23 is a table summarizing the state of components of the control architecture of FIG. 19 for different operating modes shown in FIGS. 24 to 27, which show the power system 2 in a recirculation mode (FIG. 24), a passive cooling mode (FIG. 25), an active cooling mode (FIG. 26), and a heating mode (FIG. 27), which are analogous to the operating modes previously described with reference to FIGS. 11 to 15. In FIGS. 24 to 27, the control paths shown with heavier weight indicate the thermal management unit 64 exercising supervisory control over the elements connected to such control paths to activate heating elements 36, to turn the fan 60 “on”, to turn the pump 52 “on”, or to actuate valves 24, 54, 56 to their “open” state, as the case may be.

Integration of Power System with Refrigeration Subsystem

FIG. 28 is a schematic depiction of the power system 2 of FIG. 3 when integrated with a refrigeration subsystem 200, which may be part of a heating ventilation and air conditioning (HVAC) system of a building or a mobile refrigeration unit. The first heat transfer fluid is a refrigerant (e.g., R22 or R-410A refrigerant). The refrigeration subsystem 200 includes the first heat transfer fluid flow loop 202 including, in sequential order, a compressor 204, a condenser 206, an expansion valve 208, and an evaporator 210. The operating principle of such a refrigeration subsystem 200 is known in the art. Briefly, the refrigerant enters the compressor 204, which compresses the refrigerant, to bring the refrigerant to a higher pressure and higher pressure. The refrigerant then passes to the condenser 206, which condenses the refrigerant by carrying out heat transfer from the refrigerant flowing therethrough to the air that surrounds the condenser 206. The air surrounding the condenser 206 is at a temperature lower than the refrigerant, so that the refrigerant condenses in the condenser 206, and leaves the condenser 206 as a liquid. The refrigerant then passes through the expansion valve 208, so as to reduce the pressure of the refrigerant. Some of the refrigerant may evaporate due to the reduction in pressure, but a significant portion of the refrigerant remains liquid. The reduction in pressure of the refrigerant cools the refrigerant. Thus, the refrigerant leaves the expansion valve 208 as a low pressure, low temperature liquid or liquid/gas mix. The refrigerant then passes through the evaporator 210, which transfers ambient heat to the refrigerant, in order to raise the temperature of the refrigerant so as to drive the evaporation of the refrigerant. The refrigerant then leaves the evaporator 210 and returns to the inlet of the compressor 204, where it is compressed again and sent again to the condenser 206 in a continuous cycle.

The battery pack 6 of the power system 2 is connected to an electrical load 300 via an optional bidirectional power converter 302 (e.g., a bidirectional alternating current (AC) to direct current (DC) converter). As a non-limiting example, the battery pack 6 may be used as a power bank for a building or a mobile unit. In embodiments, the battery pack 6 is an immersion-cooled battery pack and the first heat transfer fluid is a dielectric fluid, or a liquid indirect-cooled battery pack and the first heat transfer fluid may be a coolant fluid (e.g., ethylene glycol).

The power system 2 is integrated with the refrigeration subsystem 200 by connecting the inlet 26 and the outlet 28 of the heat exchanger first flow path 22 to the first heat transfer fluid flow loop 202. In this embodiment, the first heat transfer fluid valve 24 is provided on a flow path parallel to the expansion valve 208. The first heat transfer fluid valve 24 is in the form of an expansion valve that operates similarly to the expansion valve 208 of the refrigeration subsystem 200 such that refrigerant passing therethrough leaves as a relatively low pressure, low temperature liquid or liquid/gas mix. The inlet 26 of the heat exchanger first flow path 22 is connected immediately downstream of the first heat transfer fluid valve 24 so that, in the active cooling mode (FIG. 14), at least a portion of the first heat transfer fluid after flowing through the first heat transfer fluid valve 24 can be diverted to the first flow path of the heat exchanger 20. The outlet 28 of the heat exchanger first flow path 22 is connected to the first heat transfer fluid flow loop immediately downstream of the evaporator 210 so that, in the active cooling mode (FIG. 14), the portion of first heat transfer fluid that is heated by the second heat transfer fluid in the heat exchanger 20 is returned upstream of the compressor 204. This arrangement may advantageously decrease the amount of energy required by the compressor 204 to compress the refrigerant to a desired pressure and temperature, since the refrigerant is heated by the second heat transfer fluid in the heat exchanger 20.

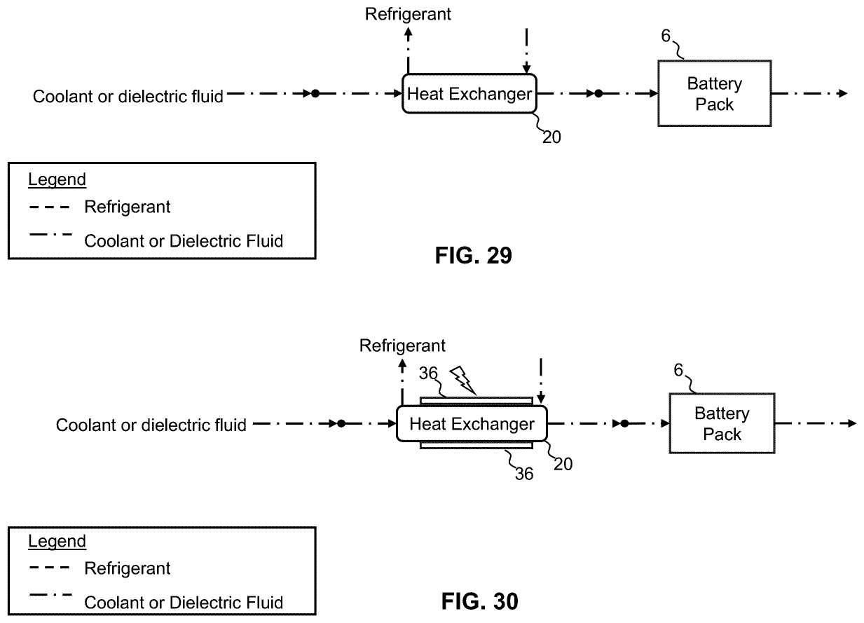

FIGS. 29 and 30 are schematic depictions of the heat transfer in the heat exchanger 20 of the power system 2 integrated with the refrigeration subsystem 200 as in FIG. 28, for the embodiment of the power system 2 in which the heat exchanger 20 of the power system 2 does not include an electrically-powered heating element 36 (FIG. 28) and for the embodiment of the power system 2 in which the heat exchanger 20 of the power system 2 includes an electrically-powered heating element 36 (FIG. 29). In FIGS. 29 and 30, the power system 2 may be in the active cooling mode as shown in FIG. 14. Comparing FIGS. 29 and 30, the provision of a heat exchanger 20 with heating elements 36 (FIG. 18) advantageously allows for heating of the second heat transfer fluid. That is, the heat exchanger 20 can be used for both cooling and heating of the second heat transfer fluid.

FIG. 31 is a schematic diagram for an embodiment of a control architecture of the power system of FIG. 3 integrated with a refrigeration subsystem as in FIG. 28. The schematic control diagram is similar to that shown in FIG. 19 and may be operated in operating modes previously described with reference to FIGS. 23 to 27. In comparison with FIG. 19, in FIG. 31, the thermal management unit 64 is additionally operatively connected by a forward control path and a feedback path to a compressor control interface 99 to control the speed of a motor of the compressor 204. The compressor control interface 99 may be similar to the pump control interface 84 as previously described with reference to FIG. 21, or it may be implemented by software and hardware elements, such as those known in the art of supervisory control and data acquisition (SCADA) control systems.

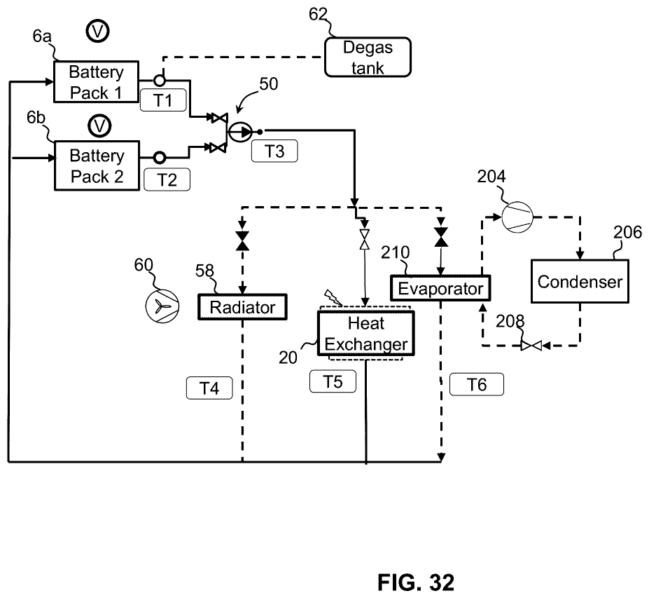

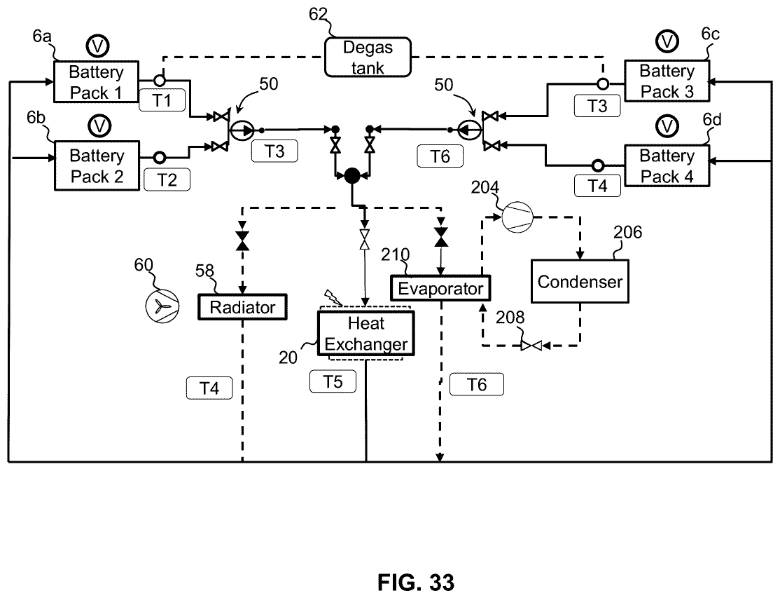

FIGS. 32 and 33 are schematic depictions of additional embodiments of a power system 2 having two battery packs 6 (FIG. 32) and four battery packs 6 (FIG. 33), when integrated with a refrigeration subsystem 200. In FIGS. 32 and 33, the heat exchanger 20 may optionally be provided with electrically-powered heating elements 36. In FIG. 32, a first battery pack 6a and a second battery pack 6b are connected in parallel with each other relative to the heat exchanger 20. In FIG. 23, a third battery pack 6c and a fourth battery pack 6d are connected in parallel with each other relative to the heat exchanger 20. The third and fourth battery packs 6c and 6c are connected in parallel with the first and second battery packs 6a and 6b relative to the heat exchanger 20. The thermal management unit 64 is operatively connected to the three-way valve and pump assemblies 50, to control the flow rate of second heat transfer fluid to each battery pack 6 relative to the other battery packs 6. For example, if the thermal management unit 64 detects that the first battery pack 6a is overheating, the thermal management unit 64 can actuate the three-way valve and pump assemblies 50 to direct a higher flow rate of the second heat transfer fluid to the first battery pack 6a.

While the description contained herein constitutes a plurality of embodiments of the present invention, it will be appreciated that the present invention is susceptible to further modification and change without departing from the fair meaning of the accompanying claims.

### LIST OF ITEMS

| Reference | | |
|---|---|---|
| number | Name of Item | FIG. |
| 2 | power system | 1, 3 |
| 4 | housing | 1 |
| 6 | battery pack | 1, 3 |
| 8 | battery management system (BMS) | 10 |
| 10 | temperature sensor for battery pack | 10 |
| 12 | voltage sensor for battery pack | 10 |
| 14 | electrical leads | 1 |
| 18 | low voltage connector | 1 |
| 20 | heat exchanger | 1, 3, 6, 7, 8 |
| 22 | heat exchanger first flow path | 4, 5 |
| 24 | first heat transfer fluid valve | 3 |
| 26 | inlet of heat exchanger first flow path | 1, 3 |
| 28 | outlet of heat exchanger first flow path | 1, 3 |
| 30 | inlet connection | 1 |
| 32 | outlet connection | 1 |
| 34 | heat exchanger second flow path | 4, 5 |
| 36 | electrically-powered heating element | 3, 6, 7, 8 |
| 38 | tube of tubular heat exchanger | 6, 7 |
| 40 | vessel of tubular heat exchanger | 6, 7 |
| 42 | stacked plates of heat exchanger | 7, 8 |
| 44 | second heat transfer fluid flow path | 3 |
| 46 | heat exchanger-inclusive flow loop | 3 |
| 48 | heat exchanger-exclusive flow loop | 3 |
| 50 | three-way valve and pump assembly | 3 |
| 52 | pump of three-way valve and pump assembly | 3 |
| 54 | second heat transfer fluid; valve of three- | 3 |
| | way valve and pump assembly for heat | |
| | exchanger-inclusive flow loop | |
| 56 | second heat transfer fluid valve; valve of | 3 |
| | three-way valve and pump assembly for | |
| | heat exchanger-exclusive flow loop | |
| 58 | radiator | 1, 3 |
| 60 | fan | 1, 3 |
| 62 | expansion tank | 1, 3 |
| 64 | thermal management unit (TMU) | 10 |
| 66 | low voltage battery | 19 |
| 68 | DC-DC converter | 19 |
| 70 | temperature sensor | 19 |
| 71 | ambient temperature sensor | |
| 72 | pressure sensor | 19 |
| 74 | level sensor | 19 |
| 76 | flow property sensor | 19 |
| 78 | flow sensor | 19 |
| 80 | forward control path from thermal management | 19 |
| | unit 34 to control interface for electrically- | |
| | powered heating elements 36 of heat | |
| | exchanger 20 | |
| 82 | feedback path from control interface for | 19 |
| | electrically-powered heating elements | |
| | 36 of heat exchanger 20 to thermal | |
| | management unit 34 | |
| 84 | control interface for pump 52 | 19 |
| 85 | feedback path for control interface 84 | |
| 86 | valve control interface for valves 54, 56 | 19 |
| 87 | feedback path for control interface 86 | |
| 88 | valve control interface for valve 24 | 19 |
| 89 | feedback path for control interface 88 | |
| 90 | control path for fan 60 | 19 |
| 92 | transformer | 19 |
| 94 | DC-DC converter | |
| 96 | high voltage charger for battery pack 6 | 19 |
| 98 | switch for charger 96 | 19 |
| 99 | compressor control interface for compressor 204 | 31 |
| 100 | electric vehicle | 16 |
| 102 | thermal management subsystem of electric | 16 |
| | vehicle | |
| 104 | first heat transfer fluid flow loop of thermal | 16 |
| | management subsystem of electric vehicle | |
| 106 | traction battery pack | 16 |
| 108 | chiller subsystem | 16 |
| 110 | Pump | 16 |
| 112 | high voltage heater subsystem | 16 |
| 200 | refrigeration subsystem | 19 |
| 202 | first heat transfer fluid flow loop of refrigeration | 19 |
| | subsystem | |
| 204 | Compressor | 19 |
| 206 | Condenser | 19 |
| 208 | expansion valve | 19 |
| 210 | Evaporator | 19 |
| 300 | electrical load | 16, 19 |
| 302 | power converter | 16, 19 |

What is claimed is:

1. A power system for integration with a thermal regulation subsystem comprising a first heat transfer fluid flow loop for transporting a first heat transfer fluid therethrough, the power system comprising:
a battery pack;
a temperature sensor for monitoring a temperature of the battery pack;
a heat exchanger comprising:
a heat exchanger first flow path that extends from an inlet for connection to the first heat transfer fluid flow loop to receive the first heat transfer fluid from the first heat transfer fluid flow loop, to an outlet for connection with the first heat transfer fluid flow loop to discharge the first heat transfer fluid to the first heat transfer fluid flow loop; and
a heat exchanger second flow path in thermal communication with the heat exchanger first flow path;
a second heat transfer fluid flow path for transporting a second heat transfer fluid therethrough, the second heat transfer fluid flow path comprising:
a heat exchanger-inclusive flow loop comprising the battery pack and the heat exchanger second flow path; and
a heat exchanger-exclusive flow loop comprising the battery pack, but excluding the heat exchanger second flow path;
a pump operable to pressurize the heat transfer liquid through the second heat transfer fluid flow path;
at least one second heat transfer fluid valve actuatable to configure the second heat transfer fluid flow path selectively in:
a heat exchanger-inclusive state to configure the second heat transfer fluid flow path for flow of the second heat transfer fluid through the heat exchanger-inclusive flow loop, but not the heat exchanger-exclusive flow loop; and
a heat exchanger-exclusive state to configure the second heat transfer fluid flow path for flow of the second heat transfer fluid through the heat exchanger-exclusive flow loop, but not the heat exchanger-inclusive flow loop; and
a thermal management unit comprising a processor operatively connected to the temperature sensor, the at least one second heat transfer fluid valve, and a non-transitory computer-readable medium comprising instructions executable by the processor to:
actuate the least one second heat transfer fluid valve to configure the second heat transfer flow path in either the heat exchanger-inclusive state or the heat exchanger-exclusive state, based at least on the temperature of the battery pack monitored by the temperature sensor.

2. The power system of claim 1:
wherein the heat exchanger comprises:
an electrically-powered heating element in thermal communication with the first flow path and the second flow path;
wherein the processor is operatively connected to the electrically-powered heating element; and
wherein the instructions are executable by the processor to activate the electrically-powered heating element based at least on the temperature of the battery pack detected by the temperature sensor, when the at least one second heat transfer fluid valve configures the second heat transfer fluid flow path in the heat exchanger-inclusive state.

3. The power system of claim 2, wherein:
the instructions are executable by the processor to:
activate the electrically-powered heating element based at least on the temperature of the battery pack monitored by the temperature sensor being less than a predefined heating mode activation temperature; and
deactivate the electrically-powered heating element based at least on the temperature of the battery pack monitored by the temperature sensor being greater than a predefined heating mode deactivation predefined temperature that is greater than the predefined heating mode activation temperature.

4. The power system of claim 1:
wherein the power system further comprises:
a first heat transfer fluid valve actuatable to selectively allow or prevent flow of the first heat transfer fluid through the heat exchanger first flow path;
wherein the processor is operatively connected to the first heat transfer fluid valve; and
wherein the instructions are executable by the processor to actuate the first heat transfer fluid valve based at least on the temperature of the battery pack monitored by the temperature sensor, when the at least one second heat transfer fluid valve configures the second heat transfer fluid flow path in the heat exchanger-inclusive state.

5. The power system of claim 4, wherein:
the instructions are executable by the processor to:
actuate the first heat transfer fluid valve to allow flow of the first heat transfer fluid through the heat exchanger first flow path based on at least one actuation condition comprising the temperature of the battery pack monitored by the temperature sensor being greater than a predefined active cooling mode activation temperature; and
actuate the first heat transfer fluid valve to prevent flow of the first heat transfer fluid through the heat exchanger first flow path based at least on the temperature of the battery pack monitored by the temperature sensor being less than a predefined active cooling mode deactivation temperature that is less than the predefined active cooling mode activation temperature.

6. The power system of claim 5, wherein:
wherein the power system comprises:
an ambient temperature sensor for monitoring an ambient air temperature; and
the at least one actuation condition comprises the ambient air temperature monitored by the ambient temperature sensor being greater than a predefined ambient air temperature.

7. The power system of claim 1:
wherein the power system further comprises:
a radiator disposed in the heat exchanger-exclusive flow loop; and
a fan positioned to blow air through the radiator;
wherein the processor is operatively connected to the fan; and
wherein the instructions are executable by the processor to activate the fan based at least on the temperature of the battery pack monitored by the temperature sensor, when the at least one second heat transfer fluid valve configures the second heat transfer fluid flow path in the heat exchanger-exclusive state.

8. The power system of claim 7, wherein:
the instructions are executable by the processor to:
activate the fan based on at least one activation condition comprising the temperature of the battery pack monitored by the temperature sensor being greater than a predefined passive cooling mode activation temperature; and
deactivate the fan based at least on the temperature of the battery pack monitored by the temperature sensor being less than a predefined passive cooling mode deactivation temperature that is less than the predefined passive cooling mode activation temperature.

9. The power system of claim 8, wherein:
wherein the power system comprises:
an ambient temperature sensor for monitoring an ambient air temperature; and
the at least one activation condition comprises the ambient air temperature monitored by the ambient temperature sensor being less than a predefined ambient air temperature.

10. The power system of claim 1, wherein:
wherein the power system further comprises:
a housing that contains the battery pack and the heat exchanger;
an electrical lead conductively connected to the battery pack and extending externally from the housing for connection to an electrical load;
an inlet connection extending externally from the housing for establishing fluid communication between the inlet of the heat exchanger first flow path and the first heat transfer fluid flow loop; and
an outlet connection extending externally from the housing for establishing fluid communication between the outlet of the heat exchanger first flow path and the first heat transfer fluid flow loop.

11. The power system of claim 1, wherein:
the battery pack is an immersion-cooled battery pack, and the second heat transfer fluid comprises a dielectric liquid.

12. The power system of claim 1, wherein:
the battery pack is a liquid indirect-cooled battery pack; and
the second heat transfer fluid comprises a coolant liquid.

13. The power system of claim 1, wherein:
the inlet of the heat exchanger first flow path is connected to the first heat transfer fluid flow loop, and the outlet of the heat exchanger first flow path is connected to the first heat transfer flow loop.

14. The power system of claim 13:
wherein the thermal regulation subsystem comprises a chiller subsystem and a heater subsystem for regulating a temperature of a second battery that is in thermal communication with the first heat transfer fluid flow loop; and
wherein the first heat transfer fluid dissipates heat from the second battery pack.

15. The power system of claim 14, wherein the second battery pack is a traction battery pack of an electric vehicle.

16. The power system of claims 14:
wherein the inlet of the heat exchanger first flow path is connected to the first heat transfer fluid flow loop downstream of the chiller subsystem; and
wherein the outlet of the heat exchanger first flow path is connected to the first heat transfer fluid flow loop downstream of the second battery.

17. The power system of claim 13:
wherein the thermal regulation subsystem comprises a refrigeration subsystem that comprises, in sequential order, a compressor, a condenser, an expansion valve, and an evaporator, collectively forming the first heat transfer fluid flow loop; and
wherein the first heat transfer fluid comprises a refrigerant.

18. The power system of claim 17:
wherein the inlet of the heat exchanger first flow path is connected to the first heat transfer fluid flow loop downstream of the expansion valve or another expansion valve downstream of the condenser in the first heat transfer fluid flow loop; and
wherein the outlet of the heat exchanger first flow path is connected to the first heat transfer fluid flow loop downstream of the evaporator and upstream of the compressor.

19. A method of regulating a temperature of a battery pack, the method comprising:
connecting a first flow path of a heat exchanger to a first heat transfer fluid flow loop of a thermal regulation subsystem, wherein the heat exchanger comprises a second flow path in thermal communication with the heat exchanger first flow path;
pumping a second heat transfer fluid through a second heat transfer fluid flow path second flow path;
using a temperature sensor, monitoring the temperature of the battery pack; and
using a processor, and based on the monitored temperature of the battery pack, actuating at least one second heat transfer fluid valve to configure the second heat transfer fluid flow path in either:
a heat exchanger-inclusive state wherein the second heat transfer fluid flows through a heat exchanger-inclusive flow loop comprising the battery pack and the heat exchanger second flow path; or
a heat exchanger-exclusive state wherein the second heat transfer fluid flows through a heat exchanger-exclusive flow loop comprising the battery pack, but excluding the heat exchanger second flow path.

20. The method of claim 19, wherein:
the heat exchanger comprises an electrically-powered heating element in thermal communication with the first flow path and the second flow path; and
the method comprises:
using the processor, and based at least on the temperature of the battery pack monitored by the temperature sensor, activating the electrically-powered heating element based at least on the temperature of the battery pack monitored by the temperature sensor, when the at least one second heat transfer fluid valve configures the second heat transfer fluid flow path in the heat exchanger-inclusive state.
